(19) United States
(12) Patent Application Publication
(10) Pub. No.: US 2026/0128909 A1
(43) Pub. Date: May 7, 2026

(54) Cryptographically Verifiable Certificates On Blockchains

(71) Applicant: Virtualness Corp., Road Town,Tortola (VG)

(72) Inventors: Saurabh S Doshi, Dubai (AE); Atif B Lodi, Dubai (AE); Kirthiga U Reddy, Las Vegas, NV (US)

(21) Appl. No.: 19/374,325

(22) Filed: Oct. 30, 2025

Related U.S. Application Data
(60) Provisional application No. 63/715,195, filed on Nov. 1, 2024.

(51) Int. Cl. H04L 9/32; H04L 9/00

(52) U.S. Cl. CPC H04L 9/3268; H04L 9/3236; H04L 9/3247; H04L 9/50

(57) ABSTRACT

A computing system may generate, manage, and verify dynamic digital credentials recorded on a distributed ledger. The system may receive credential data from an issuer, generate a cryptographic hash representing the credential content, and record the hash on a blockchain along with issuer identifiers and version references. When a credential is updated, the system may calculate and store differential data between versions to improve storage efficiency and maintain traceability. Each version may reference the previous hash, forming an immutable version chain. Recipients may store credentials in digital wallets and share verifiable credentials containing issuer signatures and refresh links for automatic updates. Verifiers may authenticate credentials by validating issuer signatures and comparing credential hashes with corresponding blockchain records, ensuring authenticity, integrity, and version transparency across decentralized systems.

### CROSS REFERENCE TO RELATED APPLICATION(S)

This application claims benefit to U.S. Provisional Application No. 63/715,196, filed on Nov. 1, 2024, which is incorporated by reference herein for all purposes.

### BACKGROUND

In traditional systems, digital credentials, certificates, and awards face several limitations, particularly in environments requiring credential information to remain current and reflective of ongoing changes. One primary issue is the static nature of conventional credentials. Once issued, these credentials generally remain unchangeable; any need for corrections, updates, or additions, such as reflecting new achievements, necessitates the issuance of a completely new credential. This reissuance process can be inefficient and burdensome for both issuers and recipients.

Another limitation is the lack of version control. Current systems lack a formalized, secure method to track and document the progression of a credential. When updates occur, there is no standardized approach to preserve an audit trail of previous versions, which can lead to confusion and uncertainty regarding the legitimacy and relevance of specific credential versions.

Additionally, traditional credentials struggle with maintaining longevity and relevance. Dynamic credentials, by contrast, are able to adapt to real-world changes, preserving their relevance over time and enhancing their value to the issuer as they respond to evolving external conditions. Traditional certificates lack programmability for real-life moments or outcomes, reducing their applicability in scenarios where responsiveness is critical.

Furthermore, static credentials lack interactivity and evolutionary potential. Dynamic credentials, however, can be designed to change over time, incorporating user interactions or other pre-set criteria, which introduces new levels of engagement. For instance, a dynamic credential could automatically unlock a reward, video, or additional content when the recipient achieves a specific status or milestone.

While current solutions may suffice for one-time issuance, they fall short in cases where credentials must evolve over time, such as when new skills, qualifications, or accomplishments need to be integrated. Moreover, challenges remain in ensuring that updates are stored and tracked transparently and securely, without risk of tampering.

### SUMMARY

In some embodiments, the disclosure described herein relate to a system including: a blockchain including a distributed ledger; and a computing system in communication with the blockchain, the computing system including memory and one or more processors, memory storing executable instructions, wherein the executable instructions, when executed by the one or more processors, cause the one or more processors to: receive a request for generating a certificate that represents credential of a named entity; apply a private cryptographic key corresponding to a certificate issuer to generate a blockchain record based on information provided in the request, the blockchain record including (1) a reference to a version of a public cryptographic key and (2) a hash of the information such that the information is cryptographically verifiable; record the blockchain record on the distributed ledger of the blockchain, wherein the blockchain record is cryptographically traceable to a blockchain address associated with the certificate issuer; generate a representation of the certificate, wherein the representation is linked to the blockchain record and is updatable based on tracing linked blockchain records on the blockchain that represent changes to the credential of the named entity; and transmit the representation of the certificate to the named entity as a credential proof.

In some embodiments, the request for generating the certificate includes an update request for a previously issued certificate.

In some embodiments, applying the private cryptographic key corresponding to the certificate issuer includes: validating claims associated with the request; generating a cryptographic hash representing the claims, wherein the cryptographic hash is the hash.

In some embodiments, recording the blockchain record on the distributed ledger includes: retrieving a previously stored credential hash associated with the certificate; comparing the cryptographic hash representing an updated credential content with the previously stored credential hash; calculating a difference representing changes between credential versions; and generating a new issuer signature corresponding to the difference.

In some embodiments, the disclosure described herein relate to a computer-implemented method, including: receiving a request for generating a certificate that represents credential of a named entity; applying a private cryptographic key corresponding to a certificate issuer to generate a blockchain record based on information provided in the request, the blockchain record including (1) a reference to a version of a public cryptographic key and (2) a hash of the information such that the information is cryptographically verifiable; recording the blockchain record on a distributed ledger of a blockchain, wherein the blockchain record is cryptographically traceable to a blockchain address associated with the certificate issuer; generating a representation of the certificate, wherein the representation is linked to the blockchain record and is updatable based on tracing linked blockchain records on the blockchain that represent changes to the credential of the named entity; and transmitting the representation of the certificate to the named entity as a credential proof.

In some embodiments, the request for generating the certificate includes an update request for a previously issued certificate.

In some embodiments, applying the private cryptographic key corresponding to the certificate issuer includes: validating claims associated with the request; generating a cryptographic hash representing the claims, wherein the cryptographic hash is the hash.

In some embodiments, recording the blockchain record on the distributed ledger includes: retrieving a previously stored credential hash associated with the certificate; comparing the cryptographic hash representing an updated credential content with the previously stored credential hash; calculating a difference representing changes between credential versions; and generating a new issuer signature corresponding to the difference.

In some embodiments, recording the blockchain record on the distributed ledger further includes: storing a new credential hash together with a previous credential hash and a corresponding issuer signature; creating a new ledger record on the distributed ledger containing an issuer identifier, the new credential hash, and a reference to the previous credential hash; and storing a ledger reference corresponding to the new ledger record.

In some embodiments, the representation of the certificate transmitted to the named entity as the credential proof includes a document, and wherein verifying authenticity of the certificate includes: including, in the document, an issuer digital signature, credential metadata, and a blockchain ledger reference; retrieving a public cryptographic key of the issuer; and authenticating the document by validating the issuer digital signature using the public cryptographic key.

In some embodiments, the disclosure described herein relate to a computer-implemented method, further including verifying authenticity of the certificate, wherein verifying the authenticity includes: computing a new hash of based on information in the representation of the certificate; retrieving, from the distributed ledger, a stored credential hash corresponding to the certificate; and determining authenticity of the certificate responsive to the new hash matching the stored credential hash recorded on the distributed ledger.

In some embodiments, generating the representation of the certificate includes: detecting an external verified event associated with the named entity; automatically initiating, responsive to the external verified event, a credential update workflow to modify credential content; and recording, on the distributed ledger, an updated credential version and a corresponding ledger entry without manual intervention from the certificate issuer.

In some embodiments, generating the representation of the certificate includes: communicating with an external system; retrieving, from the external system, verified achievement data associated with the named entity; and updating credential content based on the achievement data.

In some embodiments, representation of the certificate is human-readable, and wherein generate the representation of the certificate includes: linking the human-readable representation to blockchain records corresponding to real-life events of the named entity; updating the human-readable representation to reflect verified new event associated with the named entity; and dynamically modifying a privilege associated with the certificate based on a verified state recorded on the distributed ledger.

In some embodiments, recording the blockchain record on the distributed ledger further includes: executing a smart contract governing credential issuance; validating compliance of credential data with predefined credentialing rules; and generating an immutable transaction record confirming the credential issuance or update in accordance with the smart contract.

In some embodiments, the certificate issuer includes an entity having a decentralized identifier recorded on a decentralized identity framework, and wherein generating the blockchain record further includes: associating the decentralized identifier with a cryptographic key pair; linking the cryptographic key pair to a blockchain address of the certificate issuer; and recording a reference to the blockchain address in the distributed ledger for verifiable identification of the certificate issuer.

In some embodiments, generating the representation of the certificate includes: using a generative artificial intelligence model to create a credential template; automatically generating certificate imagery and metadata based on information provided in the request; and minting the generated certificate as a verifiable digital asset recorded on the distributed ledger.

In some embodiments, generating the representation of the certificate includes: assigning a dynamic privilege associated with the credential; storing a benefit parameter and condition in a smart contract recorded on the distributed ledger; and automatically updating the dynamic privilege when the benefit parameter and condition is met as determined by the smart contract.

In some embodiments, transmitting the representation of the certificate to the named entity includes: enabling the named entity to access a community environment based on verified credentials; tracking engagement of the named entity through a credential-linked event; and recording, on the distributed ledger, credential usage history to provide verifiable engagement information.

In some embodiments, a non-transitory computer-readable medium that is configured to store instructions is described. The instructions, when executed by one or more processors, cause the one or more processors to perform a process that includes steps described in the above computer-implemented methods or described in any embodiments of this disclosure. In some embodiments, a system may include one or more processors and memory coupled to the processors that is configured to store instructions. The instructions, when executed by one or more processors, cause the one or more processors to perform a process that includes steps described in the above computer-implemented methods or described in any embodiments of this disclosure.

### BRIEF DESCRIPTION OF THE DRAWINGS

FIG. 1 is a block diagram illustrating a system environment, in accordance with some embodiments.

FIG. 2 is a block diagram illustrating an example certificate system, in accordance with some embodiments.

FIG. 3 is a flowchart depicting a sequence diagram of creating a certificate, in accordance with some embodiments.

FIG. 4 is a flowchart depicting a sequence diagram of updating a certificate, in accordance with some embodiments.

FIGS. 5A, 5B, 5C, 5D, 5E, 5F, 5G, and 5H are conceptual diagrams illustrating various examples of user interface and product features, in accordance with some embodiments.

FIG. 6 is a conceptual diagram of a structure of an example neural network, in accordance with some embodiments.

FIG. 7A is a block diagram illustrating a chain of transactions broadcasted and recorded on a blockchain, in accordance with an embodiment.

FIG. 7B is a block diagram illustrating a connection of multiple blocks in a blockchain, in accordance with an embodiment.

FIG. 8 a flowchart depicting a certificate generation process, in accordance with some embodiments.

FIG. 9 is a block diagram illustrating components of an example computing machine, in accordance with some embodiments.

### DETAILED DESCRIPTION

The figures (FIGs.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

The described technology provides a secure and transparent way to create, update, and verify digital certificates that represent verified credentials such as academic achievements, professional qualifications, or licenses. When an authorized issuer submits a certificate request, the system generates a unique blockchain record that contains a cryptographic hash of the credential data and a reference to the issuer's public key. This record is stored on a blockchain, ensuring that each certificate is tamper-proof, traceable to its source, and independently verifiable. A readable version of the certificate is also created, allowing recipients to easily share it with others while maintaining the ability to confirm its authenticity through the blockchain.

The platform also supports dynamic credentials that can evolve over time as new, verified events occur. It can connect to trusted data sources such as learning systems, enterprise platforms, or certification databases to automatically update a credential when new achievements are recorded. Each update creates a new blockchain entry linked to earlier records, forming a transparent and permanent history of the credential's changes. This approach provides a reliable and automated framework for maintaining up-to-date, verifiable credentials that reflect a person's or organization's current status across different digital environments.

### System Overview

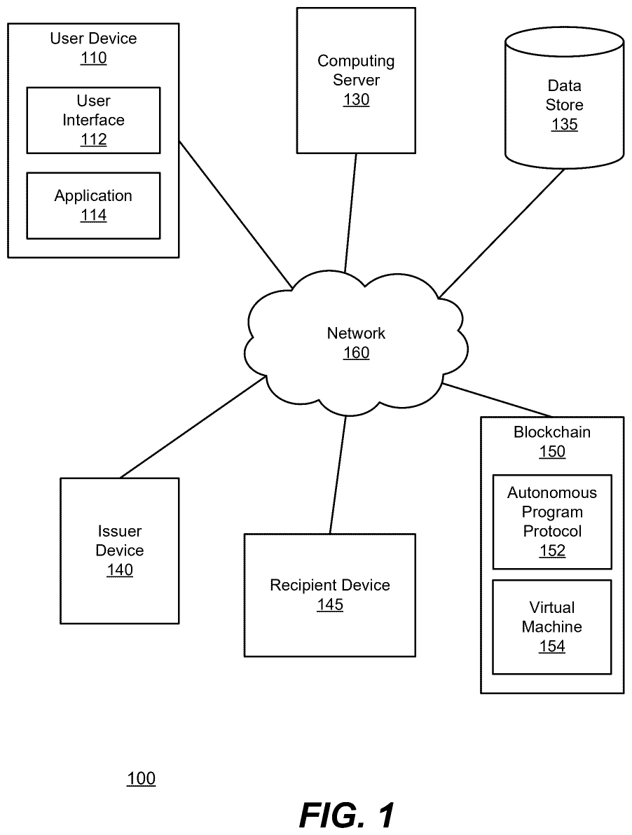

FIG. 1 is a block diagram that illustrates a system environment 100 of an example computing server, in accordance with an embodiment. By way of example, the system environment 100 includes a user device 110, computing system 130, a data store 135, an issuer device 140, a recipient device 145, a blockchain 150, and an autonomous program protocol 152. The entities and components in the system environment 100 communicate with each other through the network 160. In various embodiments, the system environment 100 may include different, fewer, or additional components. The components in the blockchain system environment 100 may each correspond to a separate and independent entity or may be controlled by the same entity. For example, in one embodiment, the computing system 130 may control the data store 135.

While each of the components in the system environment 100 is often described in disclosure in a singular form, the system environment 100 may include one or more of each of the components. For example, there can be multiple user devices 110 communicating with the computing system 130 and the blockchain 150. Also, the computing system 130 may provide service for multiple issuer devices 140, each of which communicate with different recipient devices 145. An issuer device 140 and a recipient device 145 may be an example of a user device 110. As such, while a component may be described in this disclosure in a singular form, it should be understood that in various embodiments, the component may have multiple instances. Likewise, while some of the components are described in a plural form, in some embodiments the component only has a single instance in the computing environment 100.

The components in the computing environment 100 may each correspond to a separate and independent entity or may be controlled by the same entity. For example, in some embodiments, the computing system 130 may control the data store 135. In other embodiments, the computing system 130 and the data store 135 are operated by different entities and the data store 135 provides data storage service to the computing system 130.

A user device 110 may also be referred to as a client device. A user device 110 may be controlled by a user who may be a certificate issuer, a certificate recipient, a user of the computing system 130, or a participant of the blockchain 150. In some situations, a user may also be referred to as an end user, for example, when the user is a customer who uses software applications and/or certificates to perform actions. The user device 110 may be any computing device. Examples of user devices 110 include personal computers (PC), desktop computers, laptop computers, tablet computers, smartphones, wearable electronic devices such as smartwatches, or any other suitable electronic devices.

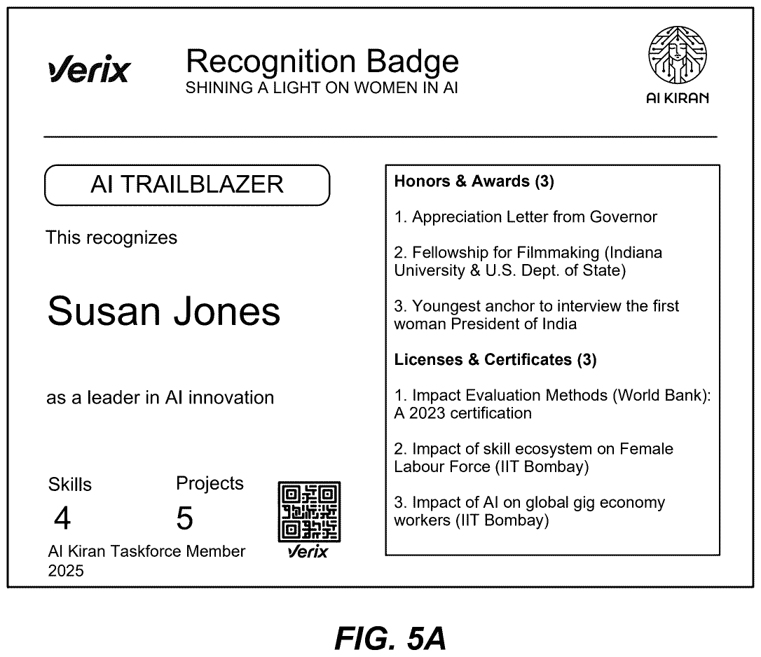

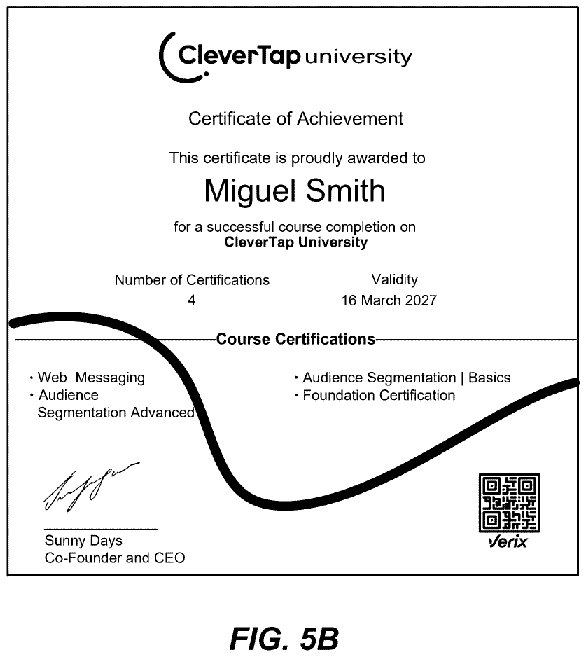

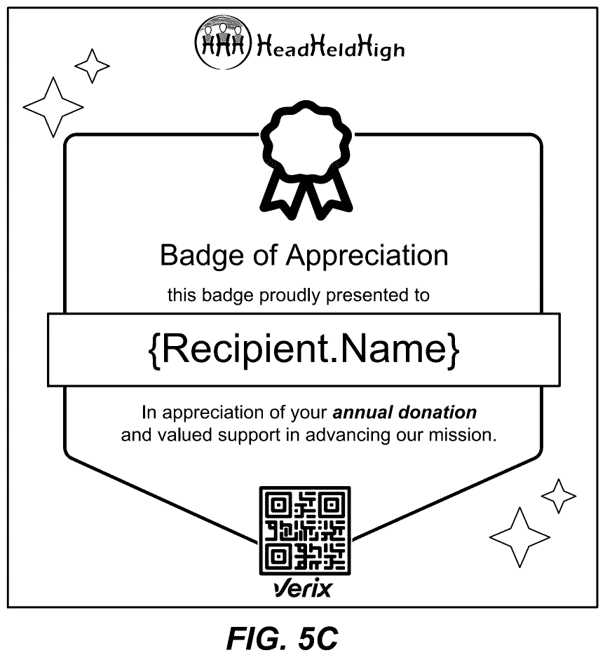

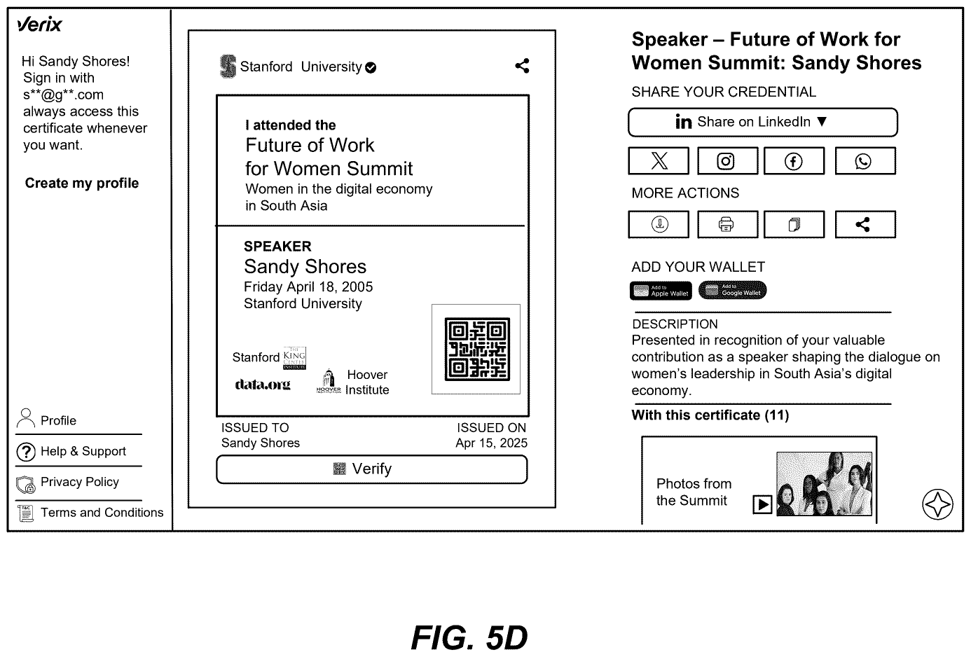

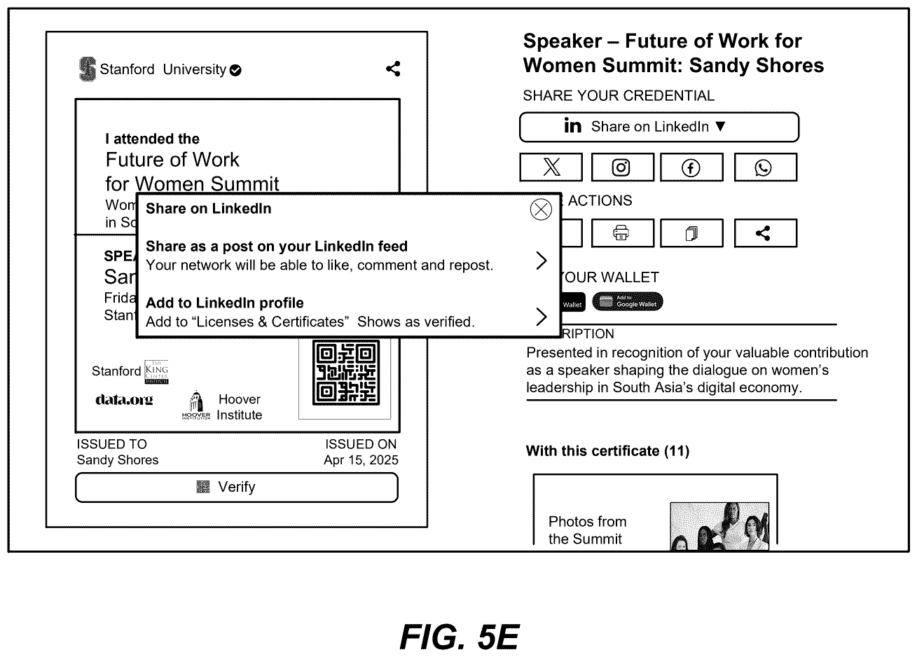

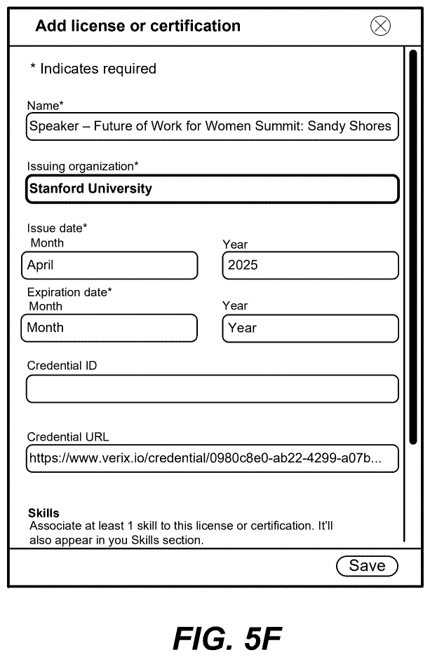

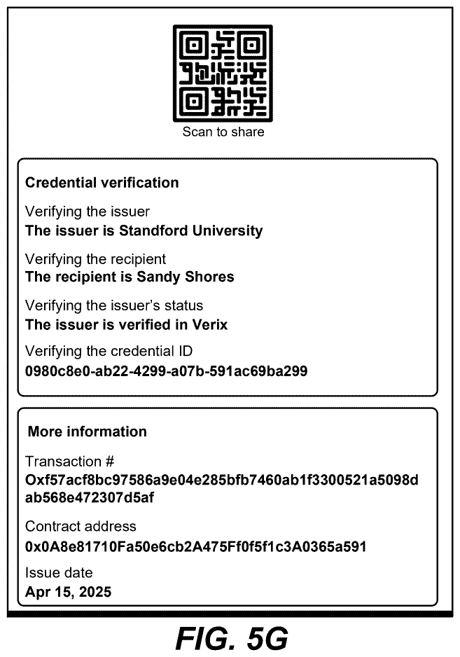

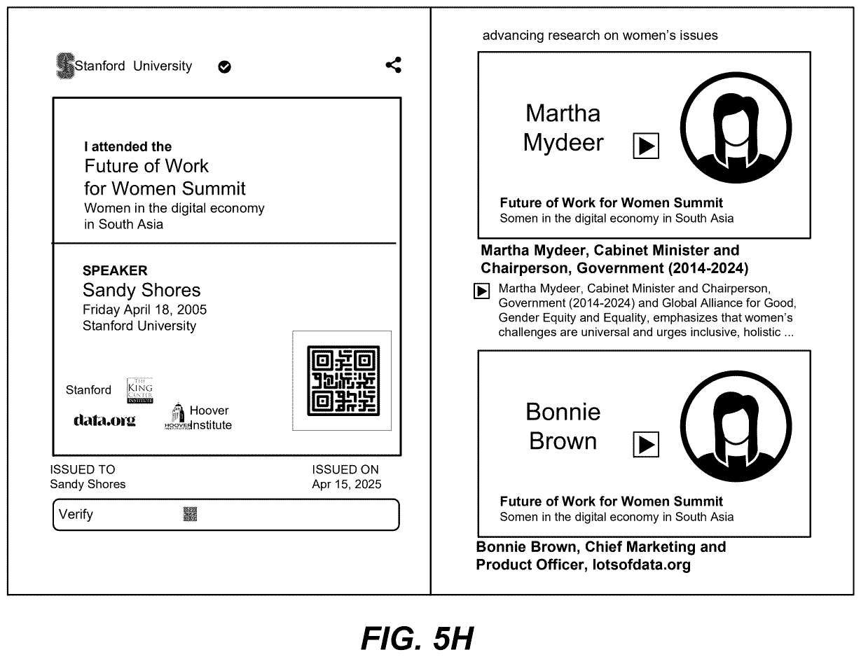

The user device 110 may include a user interface 112 and an application 114. The user interface 112 may be the interface of the application 114 and allow the user to perform various actions associated with application 114. For example, application 114 may be a software application published by the computing system 130 and the user interface 112 may be the frontend. The user interface 112 may take different forms. In one embodiment, the user interface 112 is a software application interface. For example, the computing system 130 may provide a front-end software application that can be displayed on a user device 110. In one case, the front-end software application is a software application that can be downloaded and installed on a user device 110 via, for example, an application store (App store) of the user device 110. In another case, the front-end software application takes the form of a webpage interface of the computing system 130 that allows clients to perform actions through web browsers. The front-end software application includes a graphical user interface (GUI) that displays various information and graphical elements. In another embodiment, user interface 112 does not include graphical elements but communicates with the computing system 130 via other suitable ways such as command windows or application program interfaces (APIs). Examples of various pages of the user interface 112 are discussed in FIG. 5A through FIG. 5G.

In some embodiments, a computing system 130 is configured to create, maintain, and update dynamic certificates. In some embodiments, a certificate may serve as a variety of document types, such as a digital certificate, a credential, a digital diploma, a certification of completion, an award, or even a dynamic event ticket, each adaptable to represent real-time achievements, access privileges, or specific verifications tied to the holder's ongoing accomplishments. The computing system 130 interacts with various system components to generate certificates with unique cryptographic hashes. In some embodiments, a particular version of the certificate is immutably stored on a blockchain 150 so that the certificate is secure and various dynamic versions of the certificate are traceable on the blockchain 150. When a new version of a certificate is created, the computing system 130 processes the required recipient and issuer information and produces a hash for the certificate, which is stored on a distributed ledger of the blockchain 150. This hash provides a verifiable identifier for the certificate, allowing stakeholders to confirm its authenticity and current version. In cases of certificate updates, the computing system 130 generates a new hash and applies a diff file to record the changes, which streamlines storage and retrieval processes. The computing system 130 also coordinates the logging of updates on the distributed ledger, maintaining an unalterable chain of updates for each certificate.

In various embodiments, the computing system 130 may take different suitable forms. For example, while the computing system 130 is described in a singular form, the computing system 130 may include one or more computers that operate independently, cooperatively, and/or distributively. In various embodiments, the computing system 130 may be a single server or a distributed system of servers that function collaboratively. In some embodiments, the computing system 130 may be implemented as a cloud-based service, a local server, or a hybrid system residing in both local and cloud environments. In some embodiments, the computing system 130 may be a server computer that includes one or more processors and memory that stores code instructions that are executed by one or more processors to perform various processes described herein. In some embodiments, the computing system 130 may also be referred to as a computing device or a computing server. In some embodiments, the computing system 130 may be a pool of computing devices that may be located at the same geographical location (e.g., a server room) or be distributed geographically (e.g., cloud computing, distributed computing, or in a virtual server network). In some embodiments, the computing system 130 may be a collection of servers that independently, cooperatively, and/or distributively provide various products and services described in this disclosure. The computing system 130 may also take the form of one or more virtualization instances such as a container, a virtual machine, a virtual private server, a virtual kernel, or another suitable virtualization instance.

The data store 135 includes one or more storage units such as memory that takes the form of non-transitory and non-volatile computer storage medium to store various data. The computer-readable storage medium is a medium that does not include a transitory medium such as a propagating signal or a carrier wave. The data store 135 may be used by the computing system 130 to store data related to the computing system 130, such as certificate information, credential and achievement information of the credential holder. In one embodiment, the data store 135 communicates with other components by the network 160. This type of data store 135 may be referred to as a cloud storage server. Example cloud storage service providers may include AMAZON AWS, DROPBOX, RACKSPACE CLOUD FILES, AZURE BLOB STORAGE, GOOGLE CLOUD STORAGE, etc. In another embodiment, instead of a cloud storage server, the data store 135 is a storage device that is controlled and connected to the computing system 130. For example, the data store 135 may take the form of memory (e.g., hard drives, flash memory, discs, ROMs, etc.) used by the computing system 130 such as storage devices in a storage server room that is operated by the computing system 130.

In some embodiments, an issuer device 140 may be the device controlled by a certificate issuer and the certificate issuer may delegate the process of certificate generation to the computing system 130. The issuer device 140 collects and organizes credential data, including recipient information, achievement records, and relevant metadata, and transmits this data securely to the computing system 130. Upon receiving the data, the computing system 130 generates a certificate by creating a unique cryptographic hash that serves as the certificate's identifier. This hash may be stored on a distributed ledger, establishing a record of the certificate's issuance and ensuring that the certificate can be verified by another party. For example, the record may be an immutable record stored on a public blockchain that can be verified by the pubic. The issuer device 140 may play a supervisory role, overseeing the information flow to the computing system 130, initiating requests for credential creation, and monitoring the status of the certificate. After the computing system 130 finalizes the certificate and records the certificate on the blockchain 150, the issuer device 140 notifies the recipient's device, providing a link to the credential's entry on the ledger. This link allows the recipient to view and verify the credential, ensuring transparency and secure access to the certificate's most current version, while enabling the issuer to maintain centralized oversight throughout the issuance process.

By way of example, an issuer device 140 may be operated by an institution, such as a university, to issue dynamic certificates that serve as educational credentials. For instance, the issuer device 140 could be used to create a series of diplomas reflecting various levels of academic achievement, including bachelor's, master's, doctoral degrees, course completion, or event attendance. The institution, as the certificate issuer, would collect relevant information about each graduate, such as their name, degree type, field of study, and graduation date, and send this data to the computing system 130. The computing system 130 would then generate a unique cryptographic hash for each diploma, recording this data on the distributed ledger to establish an immutable, verifiable record of the credential. Once generated, each diploma is transmitted to the recipient, in this case, the graduate or diploma holder, who can view and verify the credential through the distributed ledger. This setup ensures that diplomas remain secure, authentic, and easily verifiable, providing a transparent and tamper-proof record of academic accomplishments for both the university and its graduates.

While an education institution and its educational credentials are used as examples of issuers and certificates, the dynamic and digital certificates can be used in many other cases that are not related to education. For example, in the professional sector, a certification authority could issue certificates for industry-specific qualifications, such as technical certifications in IT or healthcare licenses, which can be updated as professionals acquire new skills or meet continuing education requirements. In government, agencies could use dynamic certificates to manage and verify official licenses or permits, such as driver's licenses or business registrations, that may require periodic renewal or updates to reflect changes in status. In the corporate world, companies could issue digital employee badges that reflect real-time information about roles, skills, or completed training, streamlining internal credentialing for promotions or project eligibility. Another use case involves event management, where organizers could issue tickets as dynamic certificates, allowing attendees to access specific event areas or redeem rewards based on their participation. In the field of healthcare, medical facilities could use dynamic certificates to document patient immunization records or medical histories, ensuring up-to-date information is readily accessible and verifiable across healthcare providers.

In some embodiments, a recipient device 145 is an electronic device operated by a certificate recipient, whom may also be referred to as a certificate holder. The holder may access, view, interact with, and share her dynamic certificates. The certificate recipient device 145 may log in to the computing system 130, verify her identity, and retrieve the latest versions of her credentials. Certificate recipients may view credential details, including achievements, updates, and associated metadata. In some embodiments, certificate recipients may in real time to reflect modifications made by issuers. In addition to viewing credentials, recipient devices 145 can receive notifications regarding updates, prompting holders to review and acknowledge changes such as new qualifications or corrected information. A recipient device 145 may facilitate sharing of credentials with third parties for verification purposes. For instance, certificate recipients may share a unique verification link, a QR code, or other secure sharing method directly from the device, allowing third parties to view and verify the authenticity and current status of the credential on the blockchain 150. For example, the recipient device 145 enables holders to share credentials with prospective employers, educational institutions, or certifying bodies requiring validation of qualifications, eliminating the need for physical documents and allowing for instant, tamper-proof verification. A certificate recipient may also post the dynamic certificates on her professional social network, such as LINKEDIN. In addition to displaying and sharing credentials, recipient devices 145 can interact with third-party platforms where credential verification is essential, such as job applications, training platforms, and membership systems. In some embodiments, the dynamic certificates may provide real-time proof of credentials, eliminating delays often associated with traditional credential verification processes.

In some embodiments, verification information recorded in a dynamic certificate may have either a temporary or permanent status, allowing the certificate to adapt to varied contexts, such as serving both as an enduring credential and a time-sensitive authorization. For example, the permanent aspect of a dynamic certificate might include information that designates the holder as a graduate, representing an unchanging accomplishment like an educational diploma. Alongside this, temporary verification data may be appended to indicate specific event-based permissions, such as proof of ticket purchase for a particular occasion. In this case, the dynamic certificate temporarily authorizes the holder to access certain event venues or restricted areas. Such configurations allow the dynamic certificate to serve dual purposes: it functions as a permanent verification of the holder's educational achievements and, concurrently, as a temporary pass or license for time-limited activities. Once the event concludes or the temporary condition expires, the temporary verification data can be removed, reverting the certificate to its core permanent status. This approach streamlines credential use, making the certificate adaptable to situations where access requirements vary based on both the credential's enduring qualifications and short-term conditions. For example, a university may hold an exclusive event for the university's alumni that requires ticket purchase. The dynamic certificate may be used in this situation.

A blockchain 150 may be a public blockchain that is decentralized, a private blockchain, a semi-public blockchain, an execution layer settling data on a public blockchain (e.g., Layer 2 blockchains, rollups), or an application-specific chain. A blockchain 150 is an example of a distributed ledger. A public blockchain network includes a plurality of nodes that cooperate to verify transactions and generate new blocks. In some implementations of a blockchain, the generation of a new block may also be referred to as a proposal process, which may be a mining process or a validation process. Some of the blockchains 150 support smart contracts, which are a set of code instructions that are stored on a blockchain 150 and are executable when one or more conditions are met. Smart contracts may be examples of autonomous program protocols 152. When triggered, the set of code instructions of a smart contract may be executed by a computer such as a virtual machine of the blockchain 150. Here, a computer may be a single operation unit in a conventional sense (e.g., a single personal computer) or may be a set of distributed computing devices that cooperate to execute the code instructions (e.g., a virtual machine or a distributed computing system). A blockchain 150 may be a new blockchain or an existing blockchain such as BITCOIN, ETHEREUM, EOS, NEO, SOLANA, AVALANCHE, etc.

While blockchain 150 is used as a primary example of a distributed ledger and at times in this disclosure the two phrases are used interchangably, a distributed ledger may also take other forms such as directed acyclic graph (DAG) ledgers (e.g., IOTA Tangle, Hedera Hashgraph), replicated state machines, consortium-based ledgers, or other consensus-based distributed databases.

Some of the blockchains 150 support autonomous program protocol 152, which is a set of code instructions that are stored on a blockchain 150 and are executable when one or more conditions are met. Examples of autonomous program protocols 152 include token contracts, smart contracts, Web3 applications, autonomous applications, distributed applications, decentralized applications (dApps), decentralized finance (DeFi) applications, protocols for decentralized autonomous organizations (DAOs), protocols that generate non-fungible tokens (NFTs), decentralized exchanges, blockchain gaming, metaverse protocols, and other suitable protocols and algorithms that may be recorded on a blockchain. Smart contracts may be examples of autonomous program protocols 152 that may be executable by a computer such as a virtual machine 154 of the blockchain 150. Here, a computer may be a single operating unit in a conventional sense (e.g., a single personal computer), a resource of the blockchain such as a virtual machine 154, or a set of distributed computing devices that cooperate to execute the code instructions (e.g., a distributed computing system). An autonomous program protocol 152 includes a set of instructions. The instructions, when executed by one or more processors, cause one or more processors to perform steps specified in the instructions. The processors may correspond to a blockchain node of the blockchain 150 or may be distributed among various nodes of the blockchain 150.

A virtual machine 154 is a resource unit of a blockchain 150. A virtual machine 154 may be a standardized software execution environment that emulates the functionality of a physical machine and allows for the execution of autonomous program protocol 152 on the virtual machine 154. A virtual machine 154 may be run by any blockchain node. In some embodiments, a virtual machine 154 may take the form of a sandboxed environment that is created within the blockchain network to execute autonomous program protocol 152. The autonomous program protocols 152 are compiled into bytecode that can be executed by the virtual machine. One example of the virtual machine 154 Ethereum Virtual Machine (EVM) that executes the programming language SOLIDITY. In some embodiments, a virtual machine 154 may operate based on binary instruction language such as WEBASSEMBLY that can be executed in a variety of environments, such as web browsers. An example of such a virtual machine 154 is Ethereum WebAssembly (EWASM) which may allow programmers to build autonomous program protocols 152 using various common programming languages.

The communications among the user device 110, the computing system 130, the data store 135, the issuer device 140, the recipient device 145 and the blockchain 150 may be transmitted via a network 160, for example, via the Internet. In one embodiment, the network 160 uses standard communications technologies and/or protocols. Thus, the network 160 can include links using technologies such as Ethernet, 802.11, worldwide interoperability for microwave access (WiMAX), 3G, 4G, LTE, 5G, digital subscriber line (DSL), asynchronous transfer mode (ATM), InfiniBand, PCI Express Advanced Switching, etc. Similarly, the networking protocols used on the network 160 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 160 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. The network 160 also includes links and packet switching networks such as the Internet.

### Example Certificate System

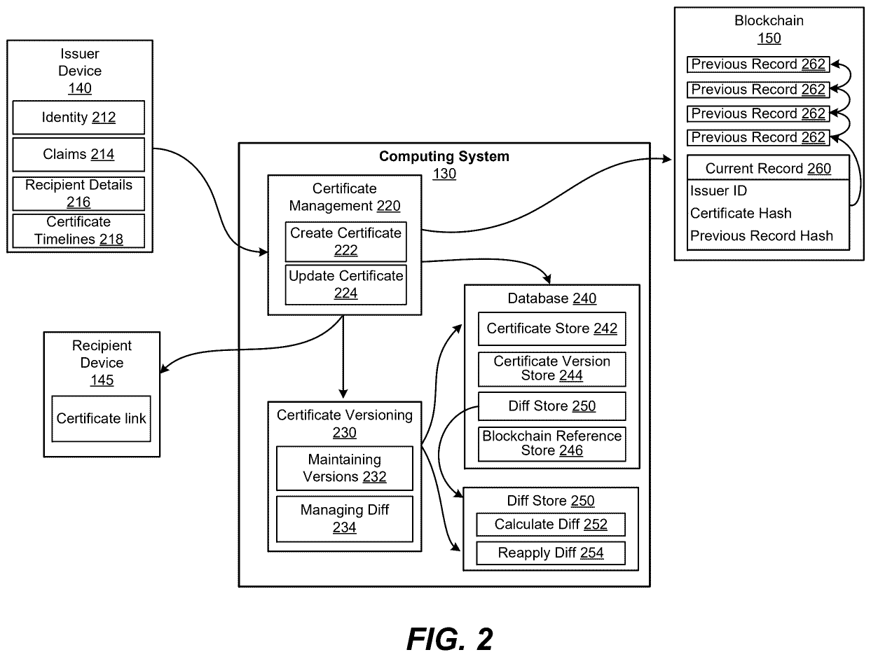

FIG. 2 is a block diagram illustrating an example certificate system, in accordance with some embodiments. In some embodiments, the computing system 130 may receive, from an issuer device 140, a request to initiate the credential issuance process by receiving input from an issuer. The input may include identity 212, claims 214, recipient details 216, and certificate timelines 218. The identity 212 may include the issuer's identity and the credential recipient's identity. An identity 212 may take different forms, such as a Decentralized Identifier (DID), a centralized public identity, an email address, a phone number, a social media handle, a biometric identifier (e.g., fingerprint or facial recognition), a government-issued ID number, or a unique account ID within a particular platform. The claims 214 may include information such as course completion, event participation, or other achievements relevant to the credential. The recipient details 216 can involve the personal information of the certificate holder. The certificate timelines 218 specify key temporal details associated with the credential, including the initial issuance date, which marks when the credential becomes valid, and any expiration date, which defines the period for which the credential remains active and recognized. Additionally, certificate timelines 218 may include scheduled review dates for periodic updates, renewal intervals for credentials that require revalidation, and historical timestamps of any modifications made to the credential. These temporal markers provide information to ensure that the credential accurately reflects current achievements and status, while maintaining a record of its lifecycle and validity over time.

In some embodiments, the computing system 130 proceeds to a certificate management engine 220 for creating 222 and updating 224 certificates. In creating 222 a certificate, the computing system 130 may generate a unique cryptographic hash based on the credential content, including recipient data, credential details, and metadata. The hash may serve as a unique identifier for the version of certificate and is recorded in a distributed ledger to link the certificate to the issuer's identity and maintain immutability. The update 224 of certificate may be performed through the certificate versioning engine 230 and information in the diff store 250. In some embodiments, certificate management engine 220 may coordinate the interaction between the engine 230, diff storage 250, and the blockchain 150. The certificate management engine 220 may oversee the issuance, updating, and verification of credentials by orchestrating the communication among the various components. Through this coordinated process, the computing system 130 may ensure that each credential update is properly versioned, recorded, and linked within the distributed ledger.

In some embodiments, the computing system 130 may use a certificate versioning engine 230 to manage versions and track changes. The certificate versioning engine 230 maintain 232 the sequential history of each credential by linking each version to the previous one through cryptographic hashes. The managing difference (diff) component 234 may calculate and manage differences between versions, storing the changes between versions in the diff store 250. By way of example, when a credential is updated, the computing system 130 may generate a new cryptographic hash representing the modified content and may compare the new hash with an existing hash of the prior version. When the hashes are identical, indicating no change in the credential content, the computing system 130 may determine that no new version is required. When the hashes differ, the computing system 130 may create a new version of the credential and may store an updated hash that references the previous version's hash. Through this chaining structure, the computing system 130 may establish a verifiable lineage of all credential versions from initial issuance to the most recent update, thereby enabling stakeholders to trace the credential's evolution over time.

In some embodiments, the computing system 130 may store the credential information and versions in a database 240. The database 240 may be an example of data store 135. The database 240 may include a certificate store 242, certificate version store 244, a diff store 250, and a blockchain reference store 246. The certificate store 242 holds the original certificate data, while the certificate version store 244 archives each version with a unique hash that references the previous version's hash. This process creates a chain of hashes, which represents a chronological link between different certificate versions. The blockchain reference store 246 may save record each certificate hash along with the previous version's hash that are also stored on the distributed ledger of a blockchain 150. The blockchain reference store 246 may also store the blockchain addresses associated with each certificate, providing a unique reference for locating and verifying the certificate's data on the blockchain. By maintaining these addresses, the blockchain reference store 246 allows the computing system 130 to retrieve specific records efficiently and maintain an association between a certificate and its corresponding blockchain entry. Each blockchain address recorded in the store corresponds to a specific transaction or update, allowing for direct access to the certificate's record as stored on the distributed ledger.

In some embodiments, the computing system 130 uses the diff store 250 to calculate 252 and reapply 254 the diff between credential versions. The calculate diff subcomponent 252 may identify changes between versions, generating a new cryptographic hash each time a modification is made. The reapply diff subcomponent 254 may use this data to reconstruct previous versions, relying on the hash links to verify the integrity and authenticity of each credential version. The diff store 250 may calculate and store the difference between two credential versions, identifying the modifications that distinguish the updated version from the prior one. The diff store 250 may also support the reconstruction of previous versions by reapplying 254 the recorded differences in reverse order. In some embodiments, the diff store 250 may be closely integrated with the certificate versioning engine 230 such that each new credential version may reference the calculated diff data stored in the diff store. By handling only the difference data rather than the full credential content, the computing system 130 may optimize storage and retrieval operations while maintaining verifiable version integrity.

In some embodiments, when a new credential version is created, the computing system 130 may generate a new current cryptographic hash corresponding to the updated credential content. This new hash may serve as a unique identifier for the latest version and may be linked to the blockchain 150 to establish a verifiable record of the update. Each new credential version may also include a reference to the previous hash, creating a continuous cryptographic chain that links all versions together for traceability. In some embodiments, the credential versioning engine 230 may generate a new digital signature for the credential using the issuer's private cryptographic key, ensuring that the updated credential can be independently verified through the issuer's corresponding public key. Additionally, the computing system 130 may create and store a diff file containing the changes between the previous and current credential versions. The diff file may specify which credential attributes were added, modified, or removed and may be stored in association with both the old and new version references. These combined elements, the new current hash, the reference to the previous hash, the newly generated issuer signature, and the stored diff file, enable a complete and verifiable version history for each credential while ensuring both data integrity and authenticity across all recorded updates.

In some embodiments, the computing system 130 interacts with a distributed ledger (e.g., a blockchain 150) to record each certificate's unique hash, which includes the issuer's identity, current certificate hash, and a reference to the previous record's hash. Each update to the credential generates a new hash linked to the previous version's hash, creating a verifiable chain of records on the distributed ledger. This ledger linkage provides a public and tamper-proof history of each credential, as each version can be verified against its cryptographic hash. The records of a certificate may include the current record 260 and a series of previous records 262 that are linked through cryptographic hash on the blockchain 150.

In some embodiments, the computing system 130 generates a certificate link that is sent to the recipient. This link provides the recipient access to their credential, along with its full version history. Each version in the credential's history is accessible and verifiable through the hash chain stored on the distributed ledger, allowing the recipient and other parties to confirm the certificate's authenticity and review its update history. Each credential may be assigned a unique cryptographic hash that corresponds to the credential's content at the time of issuance. The computing system 130 may store this hash, along with related metadata, on the distributed ledger to ensure the credential is publicly verifiable. When the credential is modified or updated, the computing system 130 may generate a new hash corresponding to the updated content and may record the new hash on the distributed ledger along with a reference to the prior version's hash. This process may create a verifiable and immutable record of each credential's state throughout its lifecycle, allowing any authorized party to validate the authenticity and version history of the credential.

### Certificate Creation

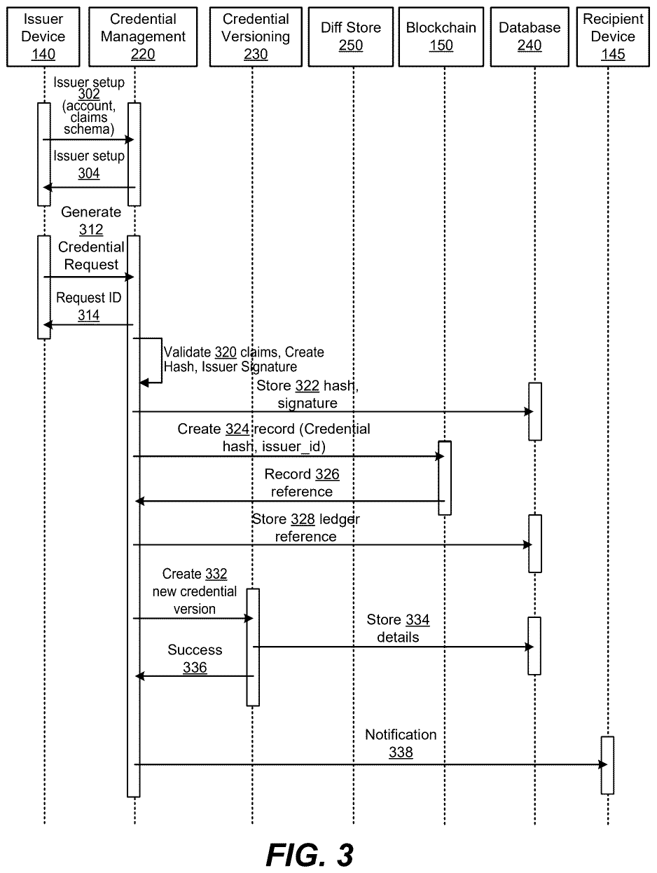

FIG. 3 is a flowchart depicting a sequence diagram of creating a certificate, in accordance with some embodiments. In various embodiments, the process illustrated in FIG. 3 represents specific sets of instructions that may be stored in one or more computer-readable media, such as memory of different devices. The instructions, when executed by one or more processors of the depicted entities, cause one or more processors to perform the described interactions. As depicted in FIG. 3, the process is performed by issuer device 140, recipient device 145, blockchain 150, and various components of computing system 130 such as credential management engine 220, credential versioning engine 230, database 240, and diff store 250. The components are merely examples that are used to illustrate some functionalities of the computing system 130. In various embodiments, the computing system 130 may not contain the precise components shown in FIG. 3. In various embodiments, the steps may also not be performed in the precise order illustrated in FIG. 3.

In some embodiments, the issuer device 140 may generate 302 an issuer setup request that includes information for establishing an issuer account and defining credential claims schema. The issuer setup process may include the creation of an authorized issuer profile on the platform of the computing system 130 and the configuration of a schema that defines the structure, type, and validation requirements of claims associated with credentials to be issued. For example, the issuer may define schema parameters such as credential name, claim type, recipient identifier, and issue date format, which provide a standardized framework for all credentials issued under the same issuer account.

In some embodiments, the credential management engine 220 of the computing system 130 may receive the issuer setup information and may generate 304 a confirmation of the setup, thereby registering the issuer as an authorized entity capable of issuing verifiable credentials. The confirmation may include assignment of a unique issuer identifier and security credentials that allow the issuer to authenticate future credential issuance transactions through the platform.

In some embodiments, the issuer device 140 may generate 312 a credential request by submitting credential data to the credential management engine 220. The credential data may include recipient information, issuer claims, and metadata such as issuance date and credential type. The credential management engine 220 may receive the credential request and may generate 314 a unique request identifier to track the credential creation process. This identifier may be used for reference throughout subsequent processing steps and may ensure that each credential request is uniquely identifiable within the system. For example, an educational institution may submit a credential request that identifies a student's course completion, along with course title, completion date, and grade, which the system tracks under a distinct request identifier.

In some embodiments, the credential versioning engine 230 of the computing system 130 may validate 320 the received claims and may create a cryptographic hash representing the credential's content. The cryptographic hash may include recipient data, credential details, metadata, and the issuer's digital signature. The resulting hash may serve as a unique identifier for the credential version. The credential versioning engine 230 may then store 322 the generated hash and associated issuer signature in a secure data store to ensure traceability and authenticity. For example, the credential versioning engine 230 may apply a hashing algorithm such as SHA-256 to generate a tamper-proof digital fingerprint of the credential data, ensuring that any future modifications to the credential would produce a different hash value. In some embodiments, the credential versioning engine 230 may also apply a private cryptographic key to generate a digital signature for the credential. The private cryptographic key may be uniquely associated with the issuer and may be managed through secure cryptographic functions of the credential versioning engine 230. The credential versioning engine 230 may use the private key to sign the credential hash, binding the issuer's identity to the credential data and enabling any verifier to confirm authenticity using the issuer's corresponding public key. In some embodiments, the private key may remain under the issuer's exclusive control, while the credential versioning engine 230 may facilitate key management operations such as secure key storage, access control, and cryptographic signing, ensuring that digital signatures are applied in a controlled and verifiable manner without direct exposure of the private key material.

In some embodiments, the credential management engine 220 may create 324 a credential record that associates the credential hash with the issuer's identity. The credential management engine 220 may then record 326 the credential reference on the blockchain 150, where the distributed ledger may serve as a publicly verifiable record of the credential issuance. In some embodiments, the blockchain record may be associated with a blockchain address that corresponds to a public cryptographic key linked to the issuer's private key used during the signing process. The blockchain address may serve as a unique identifier on the distributed ledger, allowing verifiers to confirm that the credential was issued by an authorized entity. The public key may enable any verifier to validate the digital signature applied by the private key without requiring access to the private key itself. Through this linkage between the blockchain address, the public key, and the credential record, the computing system 130 may maintain an immutable and verifiable association between each credential and the authorized issuer, ensuring that every blockchain transaction related to credential issuance is traceable to the proper source.

The blockchain 150 may immutably store 328 the ledger reference, which may include the issuer identifier, credential hash, and the transaction identifier corresponding to the credential's first entry on the ledger. For an initial credential issuance, the previous credential hash and previous transaction hash may not exist and may therefore be recorded as null or omitted. For example, when a university issues a diploma for the first time, the blockchain record may include only the current hash and the university's identifier, with no reference to prior versions since none exist.

In some embodiments, the credential versioning engine 230 may create 332 a new credential version that reflects the issuance state of the credential. The database 240 may store 334 detailed information related to the credential, including associations between the issuer, recipient, credential hash, and the corresponding ledger reference. This stored information may form the basis for future versioning and update operations, allowing the system to maintain a continuous record of credential evolution. For example, the database 240 may link each new credential version to its predecessor through a version chain, enabling verifiers to reconstruct the credential's complete modification history from issuance to the most recent update.

In some embodiments, the credential management engine 220 may transmit a success signal 336 to the issuer device 140, indicating that the credential has been successfully created and recorded. Following this confirmation, the recipient device 145 may receive a notification 338 containing a link to the verifiable credential. The notification may allow the recipient to view, download, and verify the authenticity of the credential by referencing the credential's hash and ledger record stored on the blockchain 150. Through this process, the computing system 130 may ensure the integrity, authenticity, and traceability of every credential issued within the system environment. For example, the recipient may receive a notification containing a verification link or QR code that directs to the blockchain record, allowing independent verification of credential authenticity through any compliant credential viewer.

### Certificate Update

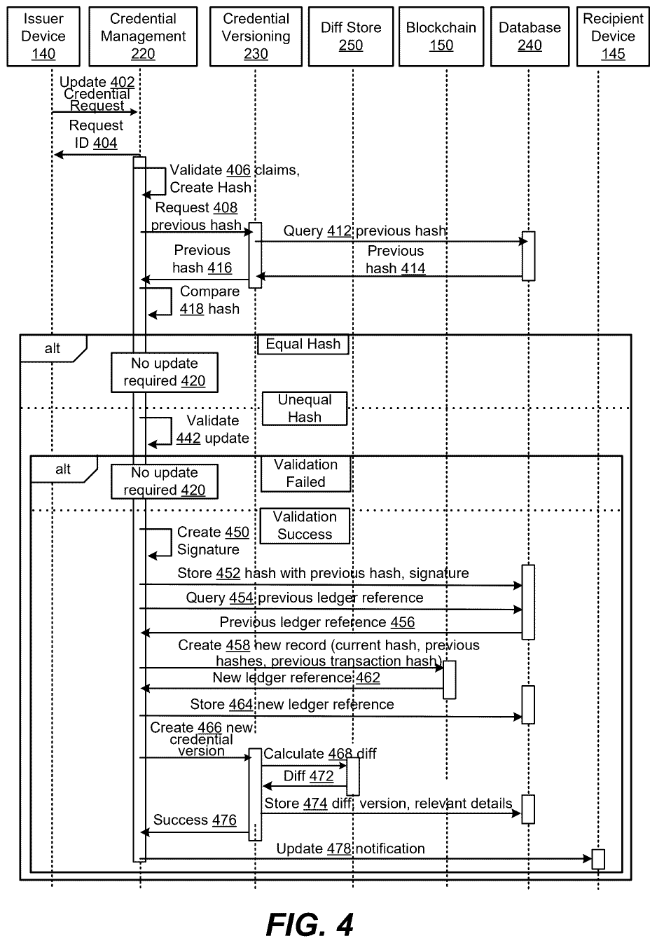

FIG. 4 is a flowchart depicting a sequence diagram of updating a certificate, in accordance with some embodiments. In various embodiments, the process illustrated in FIG. 4 represents specific sets of instructions that may be stored in one or more computer-readable media, such as memory of different devices. The instructions, when executed by one or more processors of the depicted entities, cause one or more processors to perform the described interactions. As depicted in FIG. 4, the process is performed by issuer device 140, recipient device 145, blockchain 150, and various components of computing system 130 such as credential management engine 220, credential versioning engine 230, database 240, and diff store 250. The components are merely examples that are used to illustrate some functionalities of the computing system 130. In various embodiments, the computing system 130 may not contain the precise components shown in FIG. 4. In various embodiments, the steps may also not be performed in the precise order illustrated in FIG. 4.

In some embodiments, the issuer device 140 may initiate an update 402 credential request for a previously issued credential. The update request may include information such as new achievements, corrected recipient data, or revised metadata. Upon receiving the update request, the credential management engine 220 may generate 404 a unique request identifier to track the update process and may forward the request to the credential versioning engine 230 for validation and processing. For example, an issuer may submit an update request to include an additional professional certification earned by the recipient or to correct an error in the recorded completion date, and the system may assign a unique identifier to ensure that this specific update is logged and tracked separately from prior credential versions.

In some embodiments, the credential versioning engine 230 may validate 406 claims associated with the update request and may create a cryptographic hash representing the updated credential content. In some embodiments, the credential versioning engine 230 may also apply a private cryptographic key to generate a digital signature associated with the updated hash. The private cryptographic key may be uniquely associated with the issuer and may be securely managed by the credential versioning engine 230 to prevent unauthorized access or misuse. The digital signature generated using the private key may bind the issuer's identity to the updated credential content, thereby ensuring that the update originates from an authenticated source. The corresponding public key, which may be associated with a blockchain address recorded on the distributed ledger, may be used by verifiers to confirm the authenticity of the update. Through this mechanism, the credential versioning engine 230 may preserve both the integrity and provenance of credential updates, ensuring that each version can be cryptographically traced back to the authorized issuer.

The validation process may include verifying that essential data, such as recipient identity and issuer authorization, remain consistent with the original credential. If the validation identifies any discrepancies in critical data fields, the update request may be rejected. The credential versioning engine 230 may also ensure that the updated credential adheres to the predefined claims schema established during the initial credential setup. The credential management engine 220 may request 408 previous hash. The credential versioning engine 230 may query 412 the previous credential hash 412 from the database 240. The database 240 may retrieve and return 414 the previous hash 416 associated with the credential record. For example, the validation process may confirm that the recipient's decentralized identifier (DID) remains unchanged and that the issuer's digital certificate used in the update request matches the credential's original issuer registration record.

In some embodiments, the credential versioning engine 230 may compare 418 the newly generated hash with the previously stored hash to determine whether any changes have occurred. When the computed hashes are equal, the credential management engine 220 may determine that no content modification has been made and may mark 420 the update request as not requiring further processing. When the computed hashes differ, the credential management engine 220 may proceed to validate 442 the update and, upon successful validation, the credential versioning engine 230 may create 450 a new issuer signature to accompany the updated credential version. For example, if the hash comparison confirms that new data has been added, such as a revised course grade or an added endorsement, the credential versioning engine 230 may digitally sign the updated version to authenticate the change and link it to the issuer's identity.

In some embodiments, the credential versioning engine 230 may store 452 the new hash along with the previous hash and the issuer signature. The credential management engine 220 may then query 454 the database 240 for the previous ledger reference. The database 240 may return 456 the previous ledger reference that identifies the transaction record of the last credential update. The credential management engine 220 may then create 458 a new ledger record on the blockchain 150. The new record may include the issuer identifier, the new credential hash, the previous credential hash, and the previous transaction hash corresponding to the earlier version of the credential. The blockchain 150 may return 462 a new ledger reference, and the credential management engine 220 may store 464 the new ledger reference in the database 240 for future traceability. For example, the blockchain record may contain a timestamped transaction showing the transition from the previous credential hash to the new one, allowing external verifiers to view an immutable update trail for that specific credential.

In some embodiments, the credential versioning engine 230 may create 466 a new credential version that incorporates the updated information. The diff store 250 may calculate 468 a difference (diff) file between the current and previous credential versions, identifying and recording only the changes between them. The diff file 472 may then be stored 474 in association with the new credential version, along with related metadata such as version number, timestamps, and references to the corresponding ledger record. The database 240 may maintain this data to enable reconstruction of prior versions or verification of the credential's change history. For example, the diff file may specify that only a single field, such as the “credential expiration date,” was modified, allowing the system to efficiently reconstruct either the prior or updated version by applying or reversing the diff data.

In some embodiments, upon completion of the update process, the credential management engine 220 may transmit a success signal 476 to the issuer device 140, confirming that the credential update was successfully processed and recorded. The recipient device 145 may receive an update notification 478 indicating the availability of a new credential version. The recipient may access the platform to view the updated credential, examine the version history, and verify the authenticity of the new version through the ledger reference recorded on the blockchain 150. For example, the recipient may receive an automated email or in-application alert containing a link to the updated credential page, where both the current version and prior credential versions are viewable and independently verifiable against their respective blockchain records.

In some embodiments, the computing system 130 may be configured to automatically update a credential when a predefined condition or rule is satisfied, without requiring manual action by the issuer. The rules may be established during credential setup and define event-based triggers that initiate the creation of a new credential version when a verified condition is met. For example, a student may earn a new certification through a linked learning management system (LMS), and upon verification of completion, the credential is automatically updated to include the new qualification and a new version record is generated.

In one embodiment, the computing system 130 may be integrated with an external learning management system such as LearnUpon LMS. The issuer may configure rules within the computing system 130 to specify which courses must be completed and the performance thresholds required to trigger an update. When a learner completes a designated course and achieves the required score, the computing system 130 automatically generates an updated credential version that includes the new achievement. This process eliminates the need for manual intervention by the issuer and ensures that the credential reflects the most current verified information.

In some embodiments, each credential type may have an associated schema that defines its structural composition, permissible field types, and constraints governing allowable modifications. The schema may specify which fields are immutable and which fields may be dynamically updated to preserve the integrity and trustworthiness of the credential. For example, a field representing a recipient's name or date of birth may be marked as immutable such that any attempt to alter the value results in rejection by the system, while new entries such as additional skills or certifications may be appended to the credential. The schema-based validation ensures that all updates comply with pre-established data integrity rules before a new credential version is created.

In some embodiments, the computing system 130 may include a refresh service that enables synchronization between locally stored credentials and their latest on-chain versions. Even if a credential is stored offline or within a digital wallet, the credential may include a network reference, such as a hyperlink or decentralized storage address, that allows the wallet to retrieve the most recent version. For example, when a user's digital wallet detects that a newer credential version has been recorded on the blockchain 150, the wallet may automatically refresh the displayed credential to reflect the current version. This ensures that recipients and verifiers interact with the most up-to-date credential data, even when credentials are distributed across decentralized or offline environments.

In some embodiments, the computing system 130 may implement revocation through version evolution rather than deletion or replacement of existing credentials. When a credential is superseded or expires, the system may generate a new version that explicitly marks the previous version as inactive or outdated. The prior version remains accessible and verifiable, maintaining a complete historical chain of all credential states. For example, an expired professional license may be marked as inactive in the new version while the earlier versions remain viewable, allowing verifiers to determine the exact changes and timing of status updates. This version-based revocation approach preserves transparency and provides tamper-evident auditability across the credential's entire lifecycle.

### Certificate Verification

In some embodiments, a credential may be structured as a standard JSON-LD document that enables recipients to share and transfer credential data seamlessly across multiple platforms without relying on the computing system 130. The JSON-LD document may include essential data fields such as the issuer's digital signature, references to the issuer's public cryptographic keys, credential metadata, and blockchain ledger references. Because of this standardized structure, recipients may import the credential into compatible external digital wallets or identity management systems that support the JSON-LD format. When a credential is updated, the recipient may either manually refresh the credential within the wallet or rely on an embedded refresh service defined within the JSON-LD document. The refresh service may contain a uniform resource identifier (URI) that links to the latest version of the credential, allowing external wallets or applications to automatically retrieve and synchronize the most recent credential state from the authorized source.

In some embodiments, the credential may include a reference to the issuer's public cryptographic keys, which allows a verifier to retrieve and validate the issuer's signature associated with the credential. The public keys may be hosted in a trusted key registry, a decentralized identifier (DID) document, or another verifiable key management framework. In some embodiments, when a public key is not available within a registry, the credential may contain additional information that allows for the verification of issuer identity through alternate trusted mechanisms such as certification authorities, decentralized identity networks, or other verifiable credential infrastructures. This configuration ensures that any verifier can independently confirm that the credential was signed by a recognized and authorized issuer.

In some embodiments, the verifier may authenticate the credential using the issuer's public key in combination with the credential's digital signature. The authentication process may depend on the verification method specified in the credential metadata. For example, when the verification method is based on the ECDSA Secp256k1 format, the verifier may derive the public key from the combination of the credential's signature and cryptographic hash. The verifier may then compare the derived public key to the issuer's registered public key. When the two keys match, the verifier may confirm that the credential is authentic, the issuer is valid, and the credential data has not been modified since issuance. This verification process may provide an independent, cryptographically verifiable means of confirming both issuer identity and data integrity.

In some embodiments, the verifier may further perform cross-verification of the credential through the distributed ledger such as the blockchain 150. The distributed ledger may contain immutable records that include the credential hash, the issuer's blockchain address, and references to previous credential versions when applicable. The verifier may compute a new hash of the credential being reviewed and compare the computed hash against the credential hash recorded on the distributed ledger. When the computed and stored hashes match, the verifier may determine that the credential has not been tampered with and that the credential version is consistent with the immutable blockchain record. Through this combination of JSON-LD credential structure, issuer key retrieval, signature validation, and distributed ledger verification, the computing system 130 may provide a fully decentralized and cryptographically secure mechanism for ensuring credential authenticity, integrity, and traceability across platforms and verification systems.

In some embodiments, the privileges or access rights associated with a credential may dynamically evolve in response to the credential's current version and its recorded state on the blockchain 150. The system may associate different privilege tiers, access levels, or benefits with specific credential states. For example, an event membership credential may initially authorize standard stadium access, and as the member accrues participation points or achievements, the updated credential version may unlock additional privileges such as VIP seating or priority access. The blockchain record thereby acts as the source of truth for determining the active privilege level of each credential instance.

In some embodiments, issuer and recipient identities may be represented using Decentralized Identifiers (DIDs), enabling verifiable association of credentials and credential updates with authenticated entities. Each credential record may include signatures linked to DIDs stored on the blockchain 150, ensuring that every update or version creation event can be traced to a legitimate and verifiable actor. For example, when a verifier examines the credential, the verifier can confirm that the issuer's DID remains valid and that the issuer continues to possess the authority to issue or modify credentials. This DID-based provenance chain enhances trust and accountability across federated or cross-platform credentialing systems.

### Example User Interfaces

FIG. 5A through FIG. 5G are conceptual diagrams illustrating various examples of user interface and product features described in this disclosure. The user interfaces illustrate various versions of different human-readable representations of certificate of credential of named entities, such as persons, but named entities can also be organizations.

In some embodiments, FIG. 5A illustrates a recognition badge that may be generated and displayed through the computing system 130 to acknowledge individual accomplishments or contributions. The badge interface may include information such as a title, the recipient's name, and related achievements. The badge may also present metadata such as honors, awards, licenses, and certifications associated with the credential holder. Each entry may be hyperlinked or expandable for viewing detailed information. The badge may incorporate a verification mark, which may be linked to a distributed ledger reference, allowing verifiers to confirm authenticity directly from the badge interface. In this illustration, the verification mark takes the form of a QR code. However, in various embodiments, the verification mark may also take other forms, such as a clickable hyperlink, a near-field communication (NFC) tag, a verifiable credential URL, a blockchain transaction identifier, or a scannable barcode that directs to the corresponding ledger record. This type of recognition badge may serve to highlight specific achievements or skill sets and may be displayed on professional or organizational profiles.

In some embodiments, FIG. 5B illustrates a certificate of achievement that may be created for educational or training programs. The certificate interface may display the issuing organization, recipient's name, and course-related details such as certification categories, completion date, and validity period. The certificate may include a QR code that links to a blockchain record where the certificate's authenticity can be verified. Additional metadata, such as the number of certifications or achieved modules, may be shown. The interface may also include an issuer signature field that digitally authenticates the document. The certificate may be designed to allow recipients to download, share, or embed the digital credential into their online profiles or external systems.

In some embodiments, FIG. 5C illustrates a digital badge of appreciation that may be issued by an organization to acknowledge support, participation, or donation. The badge interface may include placeholders for recipient information, descriptive text summarizing the reason for issuance, and a QR code for verification. The badge may also contain a symbolic design, such as decorative elements or organizational branding, and may link to the credential's corresponding blockchain record. Recipients may use this badge as a verifiable proof of recognition that can be shared digitally or stored within a digital wallet that supports verifiable credentials.

In some embodiments, FIG. 5D illustrates a credential presentation interface that may be generated by the computing system 130 to issue a digital award or certificate acknowledging a recipient's achievement. The interface may allow the issuer to present a verifiable record of recognition that is permanently recorded on a distributed ledger such as the blockchain 150. The credential presentation interface may include a detailed credential card displaying information such as the event title, recipient name, issuer name, issuance date, and credential type. Each credential card may further include a verification control element, such as a “Verify” button or scannable QR code, that allows any viewer to confirm the credential's authenticity by referencing the corresponding blockchain record. The interface may also include functional elements that enable the recipient to share the credential on professional or social platforms, such as LinkedIn or X, or to store the credential in compatible digital wallets, such as Apple Wallet or Google Wallet. In some embodiments, descriptive sections may provide context for the award, including the reason for issuance or the contribution recognized by the credential. The credential presentation interface may also display related media elements, such as event images, organization logos, or sponsor information, thereby enriching the visual and contextual representation of the credential while maintaining its verifiable and immutable status on the blockchain.

In some embodiments, FIG. 5E illustrates a credential sharing interface that enables recipients to distribute their credentials across various digital platforms. The interface may allow users to share credentials directly on professional networks such as LinkedIn or social media platforms including X, Instagram, and Facebook. The interface may include selectable actions for printing, downloading, or copying credential links, as well as adding the credential to digital wallets. Recipients may also choose to add the credential as a verified license or certification within a professional profile. Embedded QR codes and verification links may ensure that shared credentials remain traceable and verifiable across external environments.

In some embodiments, FIG. 5F illustrates an interface for adding a credential to a professional networking profile or digital record. The interface may include input fields for credential name, issuing organization, issue and expiration dates, credential identifier, and a credential URL. The credential URL may link to the verifiable credential record stored on a blockchain or hosted by the computing system 130. The form may support structured metadata entry, allowing users to associate relevant skills or qualifications with the credential, thereby enhancing interoperability with external professional databases or human resource systems.

In some embodiments, FIG. 5G illustrates a verification interface that displays validation results for a specific credential. The verification interface may present details such as the issuer identity, recipient identity, credential ID, and issuer verification status. The display may also include transaction identifiers and contract addresses corresponding to the blockchain record. The QR code at the top of the interface may provide a means for quick access to the credential's public verification record. Through this interface, verifiers may confirm that the credential originates from an authorized issuer, corresponds to a valid recipient, and has not been altered since issuance.

In some embodiments, FIG. 5H illustrates a credential display that may present both the credential details and associated individuals or media. The credential display may include event details such as title, date, and issuing institution, along with a QR code that links to a verification service. The interface may also feature a section showcasing related participants, such as speakers or contributors, with their respective profiles and credential associations. This view may allow for context-based exploration of credentials within a shared event or thematic framework. Each credential card or participant listing may include metadata, descriptive information, and a link to the verifiable credential record, thereby enabling transparent verification and visibility of professional achievements.

### Additional Examples and Use Cases

In some embodiments, the computing system 130 may store previous credential versions directly in a database rather than calculating and storing differential (diff) data between versions. This approach may simplify the credential management process by removing the need for complex diff computation and reconciliation processes. However, in some embodiments, this method may result in increased storage utilization, as each credential version may be stored in full rather than by reference to a prior version.

In some embodiments, instead of calculating diffs for an entire credential, the computing system 130 may compute and store diffs for specific credential sections or attributes. This selective diff calculation process may optimize data storage and retrieval by tracking and recording only modifications relevant to particular portions of a credential, such as updates to achievement data, metadata, or validity status, while maintaining unchanged data as shared references across versions.

In some embodiments, credential updates may be automatically triggered by external events. These external events may include application programming interface (API) calls received from third-party systems such as academic institutions, professional organizations, or employers. In other embodiments, the update process may be automatically executed through predefined conditions in autonomous program protocol 152 or smart contract logic recorded on the blockchain 150. Such automation may reduce the need for manual intervention from issuers and may ensure timely synchronization of credential data with verified real-world events.

In some embodiments, as an alternative to using a blockchain or other immutable distributed ledger, the computing system 130 may employ alternative technologies to achieve immutability, tamper-evidence, and verifiable proof of credential integrity. Examples of such systems may include append-only databases, cryptographically linked storage ledgers, or permissioned distributed data networks that provide equivalent guarantees of data authenticity and persistence.

In some embodiments, a global identity of an issuer may take different forms depending on the credentialing framework. The issuer identity may correspond to a centralized public identifier managed through a trusted authority or a decentralized identifier (DID) registered through a decentralized identity framework. In some embodiments, other identity mechanisms may also be employed, such as federated identity systems or verifiable credential registries that associate cryptographic keys with verified entities.

In some embodiments, the computing system 130 may support dynamic credentials that are verifiable through a blockchain record. A dynamic credential may be capable of reflecting real-world events associated with a credential holder and may record transaction hashes that correspond to the completion or occurrence of those events. The dynamic credential may continuously evolve to represent the holder's current real-time status, providing verifiable evidence of completed actions or achievements. Such a dynamic credential architecture may enable various downstream use cases, including continuous professional certification, identity-linked achievements, and event-based verifications.

In some embodiments, the computing system 130 may enable the generation of digital credentials through generative artificial intelligence (genAI). The generated credentials may be minted onto a blockchain and associated with specific benefits or privileges for the credential holder. These benefits may include access rights to digital platforms, exclusive events, or restricted resources, and may be customized through the platform interfaces of the computing system 130. The use of generative AI may facilitate rapid credential creation and personalized credential customization at scale.

In some embodiments, the computing system 130 may facilitate community engagement among credential holders belonging to a shared group or cohort. For example, a credential may be a digital diploma verifying completion of a course by a group of students, and the course provider or authorized event organizer may use the credentialing system to invite members of the cohort to subsequent events. In some embodiments, a credential may also function as a ticket for an event and may be reactivated for future use, allowing continued engagement and tracking of holder progress over time. A credential may also enable or restrict access to specific content, such as videos, documents, or digital resources, and may activate or expire certain privileges based on the credential's real-time verification status.

In some embodiments, an organization such as a university or certification authority may update credentials based on verified real-world events. The organization may manually submit updates through the credentialing system interface or may grant the computing system 130 secure access to its internal data stores. The computing system 130 may then automatically trigger updates to the credential when new verified data becomes available, ensuring that each issued credential remains current and accurately reflects the holder's ongoing achievements or status.

In some embodiments, the computing system 130 may support automatic credential updates through integration with external and internal data sources. The credential management engine 220 may communicate with systems that track achievements, milestones, and performance metrics to ensure that credentials remain accurate and up to date. These data sources may include databases, performance tracking tools, and enterprise software systems such as customer relationship management (CRM) platforms, enterprise resource planning (ERP) systems, learning management systems (LMS), and other software-as-a-service (SaaS) products. Examples of such systems may include Salesforce, SAP, or partner ecosystem platforms such as Zoom or other collaboration and educational software systems. In some embodiments, the computing system 130 may also connect to external sources such as third-party certification authorities, accreditation bodies, or professional licensing systems to capture verified updates related to credential holders.

In some embodiments, the computing system 130 may include an automated trigger mechanism that monitors connected data sources for events or updates that correspond to credential modifications. The data sources may generate event-based triggers upon detection of specific actions such as task completions, milestone achievements, course completions, or validated qualifications. The credential management engine 220 may listen to these triggers and may automatically initiate an update process when such an event occurs. This automated mechanism may ensure that credentials are continuously synchronized with verified real-world data and that any change to a credential holder's status is promptly reflected within the credential record.

In some embodiments, the computing system 130 may execute an automated update workflow upon detection of a verified event. Because the data sources are pre-verified and trusted, the trigger may directly initiate an update flow without requiring manual confirmation from the issuer. The credential versioning engine 230 may automatically apply the new information, generate a cryptographic hash representing the updated credential content, and record the update with an associated timestamp. This automated update workflow may enable real-time credential maintenance and ensure that each version of the credential remains traceable and verifiable through the blockchain 150.

In some embodiments, the standard method for performing credential updates may involve the organization transmitting the update through the computing system 130 platform. By using the computing system 130, organizations such as universities or enterprises may rely on the platform to handle blockchain-related processes, including interactions with smart contracts, management of decentralized identities, and enforcement of credentialing rules defined in the contract. The computing system 130 may abstract these complexities from the organization, allowing authorized issuers to focus solely on maintaining credential data and recipient information while ensuring compliance with blockchain transaction standards.

In some embodiments, an organization may alternatively perform credential updates directly by interacting with a smart contract on the blockchain 150 without using the computing system 130 platform. In such cases, the organization may be required to manage decentralized identities, private and public cryptographic keys, and smart contract execution parameters independently. The organization may also be responsible for ensuring adherence to all rules and conditions defined in the smart contract governing credential updates. While this direct interaction method may provide additional flexibility, it may also require greater blockchain expertise and operational oversight. For example, an institution such as a university may choose to update a credential by directly invoking a contract function using its decentralized identity, but such an approach would require management of all on-chain interactions, version records, and cryptographic validation processes without intermediary support from the computing system 130.

In some embodiments, the computing system 130 may implement a dynamic credentialing framework that enables the issuance, management, and verification of credentials recorded on an immutable distributed ledger. A credential generated by the computing system 130 may represent verifiable proof of achievements, qualifications, or participation events associated with a credential holder. Each credential may include one or more ledger references corresponding to real-life events, milestones, or verified activities of the credential holder. The credential may evolve over time by incorporating new data reflecting additional achievements or updates, thereby functioning as a living credential that dynamically changes to represent the holder's current real-time status. The computing system 130 may store each credential update as a versioned record on the blockchain 150, maintaining traceability and ensuring that every modification is cryptographically verifiable. This architecture may enable numerous downstream use cases, including continuous verification of professional progress, automated credential updates, and integration with identity-based ecosystems for dynamic trust validation.

In some embodiments, the computing system 130 may provide generative artificial intelligence (GenAI)-powered functionality for credential creation and customization. The platform may include an integrated toolkit that allows issuers to design, generate, and manage credentials efficiently while incorporating dynamically adjustable benefits or metadata. Using the GenAI tools, issuers may create credential templates, generate certificate imagery, and automatically populate credential content based on user-provided information or predefined schema. The computing system 130 may enable credential creation through multiple approaches, including template selection, document upload, or AI-assisted content generation. The platform may also provide advanced editing features that allow issuers to modify visual elements, textual fields, and embedded metadata before credential issuance. Once finalized, the credential may be minted directly onto the blockchain 150, creating a permanent, verifiable, and tamper-evident record. The integration of GenAI technology with the computing system 130 may simplify credential creation while ensuring high-quality, professional-grade outputs that combine visual design and verifiable trust features.

In some embodiments, the computing system 130 may facilitate downstream engagement through dynamic credential-linked benefits and rewards. The platform may allow issuers to interact with credential holders, extend invitations, and assign access rights or privileges associated with verified credentials. The credential may take the form of a digital diploma, award, product authenticator, event certificate, or commemorative record, each verifiable on the blockchain 150. Credential holders may use these credentials to unlock exclusive benefits such as event access, membership enrollment, restricted digital content, or promotional offers. The benefits associated with each credential may be dynamic and modifiable over time. For example, when a credential holder attains a new milestone or fulfills eligibility criteria for additional privileges, the issuer may update the credential to include new access rights or rewards. These updates may be propagated automatically through the distributed ledger, ensuring that the credential reflects the latest state of entitlement for the holder.

In some embodiments, digital credentials generated by the computing system 130 may serve as gateways to community participation and engagement. For example, a course provider may issue digital diplomas to a cohort of graduates, and these diplomas may serve as verifiable credentials granting access to alumni resources, exclusive lectures, or networking events. Event organizers may verify credentials in real time using blockchain validation, ensuring that only authorized participants gain access to secure venues or digital sessions. In some cases, the credentials may be reactivated for future events, allowing issuers to track holder engagement, progress, and continued participation. Each credential may maintain a complete, immutable history of usage and updates, ensuring transparency and verifiability throughout its lifecycle.

In some embodiments, credential holders may gain access to a connected community environment where they can participate in exclusive activities, view personalized content, and interact with other verified members. The computing system 130 may provide issuers with tools to monitor credential engagement, manage event participation, and analyze holder activity. This model may transform static credentials into active instruments of ongoing engagement, allowing issuers to foster long-term relationships with recipients. Holders may benefit from persistent access to privileges and content tied to their verified credentials, while issuers may benefit from a continuous feedback and participation ecosystem managed through the computing system 130.

In some embodiments, beyond serving as visual proof of achievement, credentials generated by the computing system 130 may also function as programmable assets that carry customizable access rights and benefits. The platform may allow issuers to define time-sensitive privileges, recurring access entitlements, or usage-limited authorizations associated with each credential. The computing system 130 may manage these associations through smart contracts recorded on the blockchain 150, ensuring that credential-based benefits are securely enforced, transparently verifiable, and automatically updated based on real-time data or event triggers. Through this approach, the computing system 130 may provide an integrated ecosystem in which verifiable credentials not only represent achievements but also dynamically unlock privileges and opportunities within trusted digital environments.

In some embodiments, an organization such as a university or certifying authority may update issued credentials based on verified real-life events. The organization may perform such updates by either manually submitting credential modifications through the computing system 130 platform or by providing the computing system 130 with secure access to the organization's internal or external data sources. When data source integration is established, the computing system 130 may automatically trigger credential updates in response to verified events, thereby ensuring that credentials remain accurate and reflect the credential holder's most recent achievements.

In some embodiments, the computing system 130 may establish data source integration with one or more systems that track achievements, milestones, and activities associated with credential holders. The data sources may include databases, performance tracking systems, and software-as-a-service (SaaS) platforms such as learning management systems (LMS), customer relationship management (CRM) systems, or other partner organization environments. Examples of such systems may include platforms such as Salesforce, SAP, or other ecosystem applications used by the issuing organization. In some embodiments, the computing system 130 may also connect with external certification authorities, accreditation bodies, or professional organizations to retrieve verified updates associated with credential holders.

In some embodiments, the computing system 130 may employ an automated trigger mechanism that detects verified real-life events from the integrated data sources. These triggers may correspond to the completion of courses, fulfillment of milestones, issuance of certifications, or other qualified activities. When a trigger event occurs, the computing system 130 may automatically initiate a credential update process. The update process may modify credential content, apply a new cryptographic hash, and record an updated ledger entry to reflect the event, ensuring that the credential remains accurate and up to date without requiring manual intervention.

In some embodiments, because the connected data sources are verified and trusted, the computing system 130 may initiate an automatic update workflow upon receiving a trigger signal. The automated workflow may retrieve the relevant new data, apply updates to the credential, and append a timestamp to record when the change occurred. The credential versioning engine 230 may then generate a new credential version, store a new hash in the blockchain 150, and maintain an immutable update history to preserve traceability and authenticity across credential versions.

In some embodiments, the standard method for performing credential updates may involve using the computing system 130 platform. By using the computing system 130, organizations may rely on the platform to manage all blockchain-related processes, including execution of smart contracts, management of decentralized identities, and enforcement of credentialing rules. The computing system 130 may abstract the complexities of distributed ledger operations, allowing the organization to focus solely on credential data, event information, and recipient management while the system handles all blockchain interactions on the organization's behalf.

In some embodiments, an organization may alternatively update credentials directly by interacting with a smart contract on the blockchain 150 without passing through the computing system 130 platform. In such configurations, the organization may need to manage its own decentralized identifiers (DIDs), cryptographic keys, and credential verification logic. The organization may also be responsible for adhering to all rules and operational parameters defined in the smart contract that governs credential issuance and updates. While this direct interaction method may provide greater operational control, it may require advanced blockchain expertise and increased operational overhead. For example, an academic institution may directly invoke a smart contract function to update a student's credential; however, such direct invocation would require the institution to manage its cryptographic key infrastructure, validate transactions, and confirm compliance with contract requirements without intermediary assistance from the computing system 130.

### Example Machine Learning Models

In various embodiments, a wide variety of machine learning techniques may be used. Examples include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN) and long short-term memory networks (LSTM), transformers, attention models, generative adversarial networks (GANs) may also be used. For example, various machine learning models that are used to generate digital certificate or NFT that is linked to the certificate.

In various embodiments, the training techniques for a machine learning model may be supervised, semi-supervised, or unsupervised. In supervised learning, the machine learning models may be trained with a set of training samples that are labeled. For example, for a machine learning model trained to predict if a request is noncompliant, the training samples may be past transactions labeled with compliant or noncompliant. The labels for each training sample may be binary or multi-class. In training a machine learning model related to certificates, the training samples may be past certificates created with contextual data and other historical data of the certificate holders. In some cases, an unsupervised learning technique may be used. The samples used in training are not labeled. Various unsupervised learning technique such as clustering may be used.

A machine learning model may be associated with an objective function, which generates a metric value that describes the objective goal of the training process. For example, the training may intend to reduce the error rate of the model in predicting whether a request is noncompliant. In such a case, the objective function may monitor the error rate of the machine learning model. Such an objective function may be called a loss function. Other forms of objective functions may also be used, particularly for unsupervised learning models whose error rates are not easily determined due to the lack of labels. In various embodiments, the error rate may be measured as cross-entropy loss, L1 loss (e.g., the sum of absolute differences between the predicted values and the actual value), L2 loss (e.g., the sum of squared distances).

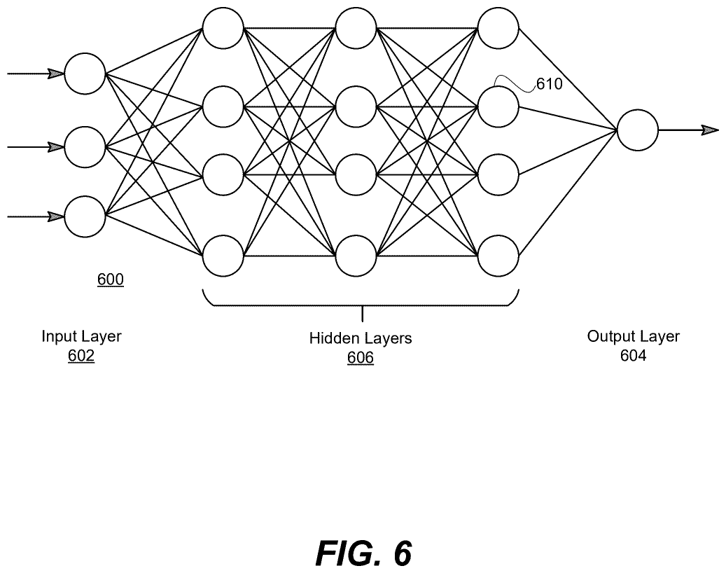

Referring to FIG. 6, a structure of an example neural network is illustrated, in accordance with some embodiments. The neural network 600 may receive an input and generate an output. The neural network 600 may include different kinds of layers, such as convolutional layers, pooling layers, recurrent layers, full connected layers, and custom layers and different nodes 610. A convolutional layer convolves the input of the layer (e.g., an image) with one or more kernels to generate different types of images that are filtered by the kernels to generate feature maps. Each convolution result may be associated with an activation function. In some embodiments, a pair of convolutional layer may be followed by a recurrent layer that includes one or more feedback loop. The feedback may be used to account for spatial relationships of the features in text or temporal relationships of objects. The layers and may be followed in multiple fully connected layers that have nodes connected to each other. The fully connected layers may be used for classification and object detection. In one embodiment, one or more custom layers may also be presented for the generation of a specific format of output. For example, a custom layer may include layers such as attention layers in transformers for generating language.

The order of layers and the number of layers of the neural network 600 may vary in different embodiments. In various embodiments, a neural network 600 includes one or more layers 602, 604, and 606, but may or may not include any pooling layer or recurrent layer. If a pooling layer is present, not all convolutional layers are always followed by a pooling layer. A recurrent layer may also be positioned differently at other locations of the CNN. For each convolutional layer, the sizes of kernels (e.g., 3×3, 5×5, 7×7, etc.) and the numbers of kernels allowed to be learned may be different from other convolutional layers.

A machine learning model may include certain layers, nodes, kernels and/or coefficients. Training of a neural network, may include forward propagation and backpropagation. Each layer in a neural network may include one or more nodes, which may be fully or partially connected to other nodes in adjacent layers. In forward propagation, the neural network performs the computation in the forward direction based on outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Each of the functions in the neural network may be associated with different coefficients (e.g. weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tanh), and rectified linear unit functions (ReLU). After an input is provided into the neural network and passes through a neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be iteratively performed. Training may be completed when the objective function has become sufficiently stable (e.g., the machine learning model has converged) or after a predetermined number of rounds for a particular set of training samples. The trained machine learning model may be re-trained such as in fine tuning, alignment, etc.

### Example Blockchain Architecture

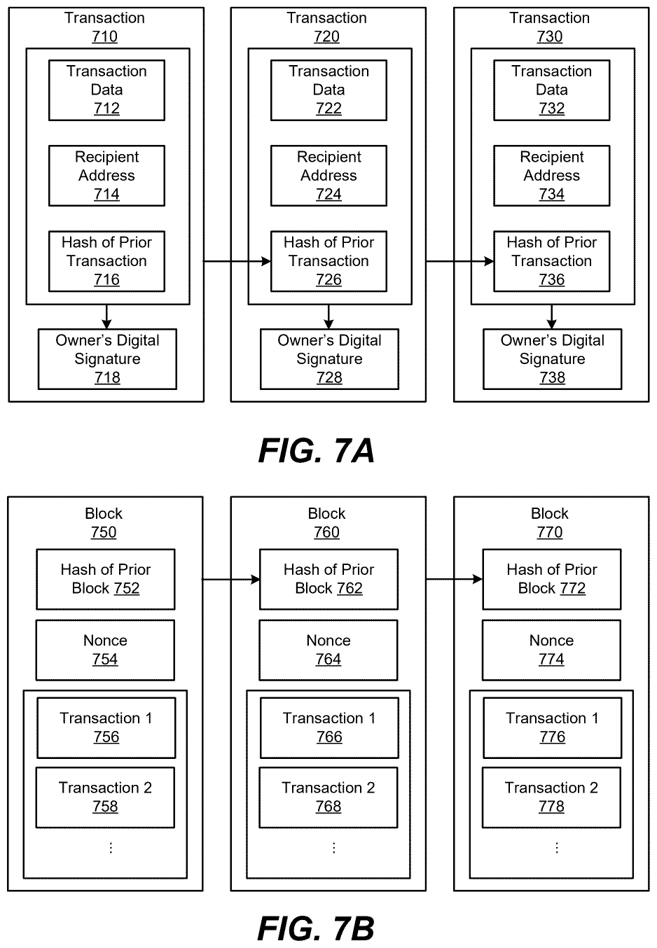

FIG. 7A is a block diagram illustrating a chain of transactions broadcasted and recorded on a blockchain, in accordance with an embodiment. The transactions described in FIG. 7A may correspond to any of the transactions and recordation of certificate records described in previous figures.

In some embodiment, a blockchain is a distributed system. A distributed blockchain network may include a plurality of nodes. Each node is a user or a server that participates in the blockchain network. In a public blockchain, any participant may become a node of the blockchain. The nodes collectively may be used as a distributed computing system that serves as a virtual machine of the blockchain. In some embodiments, the virtual machine or a distributed computing system may be simply referred to as a computer. Any users of a public blockchain may broadcast transactions for the nodes of the blockchain to record. Each user's digital wallet is associated with a private cryptographic key that is used to sign transactions and prove the ownership of a blockchain-based unit.

The ownership of a blockchain-based unit may be traced through a chain of transactions. In FIG. 7A, a chain of transactions may include a first transaction 710, a second transaction 720, and a third transaction 730, etc. Each of the transactions in the chain may have a fairly similar structure except the very first transaction in the chain. The first transaction of the chain may be generated by a smart contract or a mining process and may be traced back to the smart contract that is recorded on the blockchain or the first block in which it was generated. While each transaction is linked to a prior transaction in FIG. 7A, the transaction does not need to be recorded on consecutive blocks on the blockchain. For example, the block recording the transaction 710 and the block recording the transaction 720 may be separated by hundreds or even thousands of blocks. The traceback of the prior block is tracked by the hash of the prior block that is recorded by the current block. In some embodiments, account model is used and transactions do not have any references to previous transactions. Transactions are not chained and does not contain the hash of the previous transaction.

Referring to one of the transactions in FIG. 7A, for illustration, the transaction 720 may be referred to as a current transaction. Transaction 710 may be referred to as a prior transaction and transaction 730 may be referred to as a subsequent transaction. Each transaction includes a transaction data 722, a recipient address 724, a hash of the prior transaction 726, and the current transaction's owner's digital signature 728. The transaction data 722 records the substance of the current transaction 720. For example, the transaction data 722 may specify a transfer of a quantity of a blockchain-based unit (e.g., a coin, a blockchain token, etc.). In some embodiments, the transaction data 722 may include code instructions of a smart contract.

The recipient address 724 is a version of the public key that corresponds to the private key of the digital wallet of the recipient. In one embodiment, the recipient address 724 is the public key itself. In another embodiment, the recipient address 724 an encoded version of the public key through one or more functions such as some deterministic functions. For example, the generation of the recipient address 724 from the public key may include hashing the public key, adding a checksum, adding one or more prefixes or suffixes, encoding the resultant bits, and truncating the address. The recipient address 724 may be a unique identifier of the digital wallet of the recipient on the blockchain.

The hash of the prior transaction 726 is the hash of the entire transaction data of the prior transaction 710. Likewise, the hash of the prior transaction 736 is the hash of the entire transaction data of the transaction 720. The hashing of the prior transaction 710 may be performed using a hashing algorithm such as a secure hash algorithm (SHA) or a message digest algorithm (MD). In some embodiments, the owner corresponding to the current transaction 720 may also use the public key of the owner to generate the hash. The hash of prior transaction 726 provides a traceback of the prior transaction 710 and also maintains the data integrity of the prior transaction 710.

In generating a current transaction 720, the digital wallet of the current owner of the blockchain-based unit uses its private key to encrypt the combination of the transaction data 722, the recipient address 724, and the hash of prior transaction 726 to generate the owner's digital signature 728. To generate the current transaction 720, the current owner specifies a recipient by including the recipient address 724 in the digital signature 728 of the current transaction 720. The subsequent owner of the blockchain-based unit is fixed by the recipient address 724. In other words, the subsequent owner that generates the digital signature 738 in the subsequent transaction 730 is fixed by the recipients address 724 specified by the current transaction 720. To verify the validity of the current transaction 720, any nodes in the blockchain network may trace back to the prior transaction 710 (by tracing the hash of prior transaction 726) and locate the recipient address 714. The recipient address 714 corresponds to the public key of the digital signature 728. Hence, the nodes in the blockchain network may use the public key to verify the digital signature 728. Hence, a current owner who has the blockchain-based unit tied to the owner's blockchain address can prove the ownership of the blockchain-based unit. In this disclosure, it can be described as the blockchain-based unit being connected to a public cryptographic key of a party because the blockchain address is derived from the public key. For example, the computing system 130 may own blockchain-based units in a machine learning model. The blockchain-based units are connected to one of the public cryptographic keys of the computing system 130.

The transfer of ownership of a blockchain-based unit may be initiated by the current owner of the blockchain-based unit. To transfer the ownership, the owner may broadcast the transaction that includes the digital signature of the owner and a hash of the prior transaction. A valid transaction with a verifiable digital signature and a correct hash of the prior transaction will be recorded in a new block of the blockchain through the block generation process.

FIG. 7B is a block diagram illustrating a connection of multiple blocks in a blockchain, in accordance with an embodiment. Each block of a blockchain, except the very first block which may be referred to as the genesis block, may have a similar structure. The blocks 750, 760, and 760 may each include a hash of the prior blockchain 752, a nonce 754, and a plurality of transactions (e.g., a first transaction 756, a second transaction 758, etc.). Each transaction may have the structure shown in FIG. 7A.

In a block generation process, a new block may be generated through mining or voting. For a mining process of a blockchain, any nodes in the blockchain system may participate in the mining process. The generation of the hash of the prior block may be conducted through a trial and error process. The entire data of the prior block (or a version of the prior block such as a simplified version) may be hashed using the nonce as a part of the input. The blockchain may use a certain format in the hash of the prior block in order for the new block to be recognized by the nodes as valid. For example, in one embodiment, the hash of the prior block needs to start with a certain number of zeroes in the hash. Other criteria of the hash of the prior block may also be used, depending on the implementation of the blockchain.

In a voting process, the nodes in a blockchain system may vote to determine the content of a new block. Depending on the embodiment, a selected subset of nodes or all nodes in the blockchain system may participate in the votes. When there are multiple candidates new blocks that include different transactions are available, the nodes will vote for one of the blocks to be linked to the existing block. The voting may be based on the voting power of the nodes.

By way of example of a block generation process using mining, in generating the hash of prior block 762, a node may randomly combine a version of the prior block 750 with a random nonce to generate a hash. The generated hash is somewhat a random number due to the random nonce. The node compares the generated hash with the criteria of the blockchain system to check if the criteria are met (e.g., whether the generated hash starts with a certain number of zeroes in the hash). If the generated hash fails to meet the criteria, the node tries another random nonce to generate another hash. The process is repeated for different nodes in the blockchain network until one of the nodes find a hash that satisfies the criteria. The nonce that is used to generate the satisfactory hash is the nonce 764. The node that first generates the hash 762 may also select what transactions that are broadcasted to the blockchain network are to be included in the block 760. The node may check the validity of the transaction (e.g., whether the transaction can be traced back to a prior recorded transaction and whether the digital signature of the generator of the transaction is valid). The selection may also depend on the number of broadcasted transactions that are pending to be recorded and also the fees that may be specified in the transactions. For example, in some embodiments, each transaction may be associated with a fee (e.g., gas) for having the transaction recorded. After the transactions are selected and the data of the block 760 is fixed, the nodes in the blockchain network repeat the trial and error process to generate the hash of prior block 772 by trying different nonce. In embodiments that use voting to generate new blocks, a nonce may not be needed. A new block may be linked to the prior block by including the hash of the prior block.

New blocks may be continued to be generated through the block generation process. A transaction of a blockchain-based unit (e.g., an electronic coin, a blockchain token, etc.) is complete when the broadcasted transaction is recorded in a block. In some embodiment, the transaction is considered settled when the transaction is considered final. A transaction is considered final when there are multiple subsequent blocks generated and linked to the block that records the transaction.

In some embodiments, some of the transactions 756, 758, 766, 768, 776, 778, etc. may include one or more smart contracts. The code instructions of the smart contracts are recorded in the block and are often immutable. When conditions are met, the code instructions of the smart contract are triggered. The code instructions may cause a computer (e.g., a virtual machine of the blockchain) to carry out some actions such as generating a blockchain-based unit and broadcasting a transaction documenting the generation to the blockchain network for recordation.

### Example Process

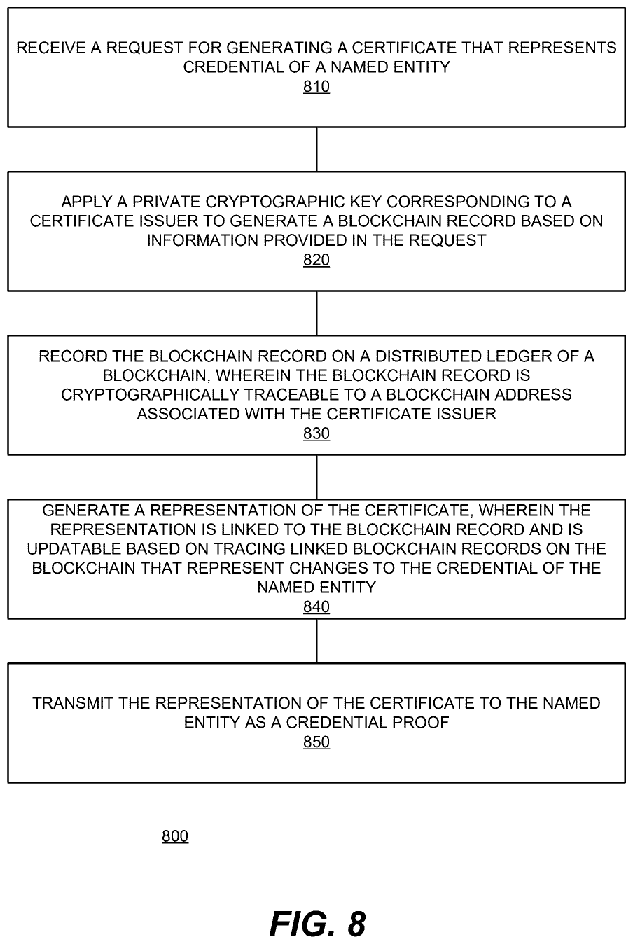

FIG. 8 is a flow chart depicting an example certificate creation process 800, in accordance with some embodiments. While the process 800 is depicted as being performed by a computing system 130, the process 800 may also be performed by any suitable devices. Also, in various embodiments, the process 800 may include fewer, additional, or different steps. The steps may also be performed in an order different from what is explicitly illustrated in FIG. 8.

In some embodiments, the computing system 130 may receive 810 a request for generating a certificate that represents a credential of a named entity. The named entity may be an individual, organization, or digital identity registered within the credentialing platform. The request may originate from an issuer device operated by an authorized issuer such as a university, professional certification authority, or enterprise organization. The request may include various data elements such as recipient identity, claims, credential metadata, and issuance parameters. For example, the recipient identity may include a decentralized identifier (DID), an email address, a phone number, a user account ID, or other identifying information. The claims may correspond to achievements, qualifications, or other verified information that the certificate is intended to represent. The credential metadata may include details such as credential type, issuance date, expiration date, and revision history.

In some embodiments, the computing system 130 may receive the request through an application programming interface (API), a web-based user interface, or a mobile application interface provided to the issuer. The issuer device may authenticate itself to the computing system 130 through cryptographic credentials or identity verification processes to ensure that only authorized entities can initiate certificate creation or updates. For example, an educational institution may submit credential issuance data through a secure web portal, whereas a third-party enterprise system may transmit a credential update request through a standardized API endpoint.

In some embodiments, the request for generating the certificate may comprise an update request for a previously issued certificate. The update request may be used to modify, correct, or append new data to an existing credential. For example, a university may update a student's academic record to include an additional certification or correct an error in a recorded completion date. Similarly, a professional organization may add new achievements or revalidate credentials that require periodic renewal. When such an update request is received, the computing system 130 may associate it with an existing certificate record by referencing the certificate's unique identifier or hash stored in a distributed ledger.

In some embodiments, the computing system 130 may generate a unique request identifier to track processing of each received request. This identifier may serve as a transaction reference, ensuring that each issuance or update process is traceable within the system. The identifier may also allow the issuer and recipient to query the status of credential generation or update. For example, when a request is submitted, the computing system 130 may return a unique request ID that the issuer can later use to confirm that the credential has been successfully recorded on the blockchain.

In some embodiments, before processing the request, the computing system 130 may validate the input data to ensure that it conforms to a predefined credential schema. The schema may specify required fields, acceptable data formats, and validation rules. The validation process may verify, for example, that the issuer identity matches a registered account, that the recipient identifier is valid, and that the provided claims adhere to the defined structure of the credential type. If the system detects any inconsistencies or missing data, the request may be flagged or rejected.

In some embodiments, the computing system 130 may categorize the request based on the credential type and processing mode. For instance, a creation request may initiate the generation of a new blockchain record, whereas an update request may trigger comparison and version control processes. These distinctions help ensure proper handling of both newly issued and previously existing credentials.

In some embodiments, the computing system 130 may log metadata associated with the received request, including timestamps, issuer identity, and the method of submission. Such metadata enables full auditability and traceability of credential creation and update operations. The system may store these logs in an internal database or on-chain record for compliance and verification purposes. Through these mechanisms, the computing system 130 provides a secure, verifiable, and traceable process for receiving requests to generate or update certificates representing the credentials of named entities.

In some embodiments, the computing system 130 may apply 820 a private cryptographic key corresponding to a certificate issuer to generate a blockchain record based on information provided in the request. The private cryptographic key may be securely stored and managed within a protected key management module of the computing system 130 or within a hardware security module (HSM) controlled by the issuer. The use of a private cryptographic key ensures that only the authorized issuer can generate or modify a credential associated with its identity. This process establishes authenticity and prevents unauthorized issuance or tampering.

In some embodiments, to apply the private cryptographic key corresponding to the certificate issuer to generate the blockchain record, the computing system 130 may validate claims associated with the request. The validation process may include checking whether the credential claims conform to a predefined schema established by the issuer, confirming that the recipient identity is valid, and verifying that the credential type and metadata are consistent with the issuer's authorization. For example, if the credential corresponds to a university degree, the computing system 130 may verify that the degree type, major, and issuance date match institutional records. Similarly, for a professional certification, the validation may include confirming that the recipient has met required qualifications.

In some embodiments, the computing system 130 may generate a cryptographic hash representing the claims. The cryptographic hash may be a fixed-length output derived from the credential data through a secure hash algorithm, such as SHA-256 or Keccak-256. The hash serves as a unique fingerprint of the credential information, ensuring data integrity and enabling future verification without disclosing the actual credential data. Each time the credential data changes, a new hash is generated, which distinguishes one version from another.

In some embodiments, the computing system 130 may apply the private cryptographic key to digitally sign the cryptographic hash to bind the identity of the certificate issuer to the credential claims. The digital signature may be generated using asymmetric cryptography, such as the Elliptic Curve Digital Signature Algorithm (ECDSA) or RSA, where the private key is used for signing and the corresponding public key is used for verification. The resulting digital signature confirms that the credential was issued by the authentic entity controlling the private key and that the credential data has not been modified since signing.

In some embodiments, the blockchain record generated by the computing system 130 may include a reference to a version of a public cryptographic key corresponding to the certificate issuer. A version of the public cryptographic key may refer to a particular instance of a public key in a key rotation sequence, a derivation from a root public key, or a blockchain address derived from the public key. For example, an issuer may periodically rotate its cryptographic key pairs to enhance security. Each new key pair represents a new version of the public cryptographic key, and references to earlier versions allow verification of historical records. The public key reference recorded in the blockchain record ensures that any verifier can retrieve the correct key version when validating a credential or its prior updates.

In some embodiments, the blockchain record may also include a hash of the credential information such that the information is cryptographically verifiable. By recording the hash rather than the raw credential data, the system preserves privacy while still allowing independent verification of authenticity. When a verifier recomputes the hash from the credential data and compares it with the hash stored on the distributed ledger, any discrepancy indicates that the credential data has been altered or is invalid.

In some embodiments, the process of generating and signing the blockchain record may be performed within a secure execution environment of the computing system 130. This environment may prevent exposure of private keys and sensitive credential data during the signing process. The system may also timestamp the generated blockchain record to record the exact time of issuance or update, which contributes to establishing an immutable credential history.

In some embodiments, the blockchain record generated may also contain metadata linking it to previous credential versions. For example, if the request corresponds to an update, the new blockchain record may include a pointer to the prior record's hash, forming a cryptographic chain of trust between credential versions. This linkage ensures that each credential instance is traceable through all updates and verifiable against historical records.

Through the application of the private cryptographic key, the generation of cryptographic hashes, and the creation of a signed blockchain record, the computing system 130 ensures that each credential issued or updated is securely bound to its authorized issuer and that the credential's data integrity and provenance are independently verifiable.

In some embodiments, the computing system 130 may record 830 the blockchain record on a distributed ledger of a blockchain. The distributed ledger serves as a decentralized and tamper-evident record of credential issuance and updates. Each blockchain record written to the ledger becomes an immutable transaction that can be independently verified by any participant in the network. The computing system 130 may interact with a blockchain node through an API, a smart contract, or a blockchain middleware service to submit the blockchain record for inclusion in the distributed ledger. Once recorded, the transaction may be timestamped and associated with a unique transaction identifier, establishing a permanent proof of issuance or update.

In some embodiments, recording the blockchain record may involve retrieving a previously stored credential hash associated with the certificate. The previously stored hash represents the prior state or version of the credential, allowing the system to determine whether the credential content has changed. The computing system 130 may compare the cryptographic hash representing an updated credential content with the previously stored credential hash to detect any modification or new information. If the two hashes match, the system may determine that no change has occurred and may bypass the recording of a new blockchain entry. However, if the hashes differ, the computing system 130 may calculate a difference, sometimes referred to as a “diff”, representing the specific changes between credential versions, such as updated achievements, corrected metadata, or new privileges associated with the credential.

In some embodiments, when a modification is detected, the computing system 130 may generate a new issuer signature corresponding to the difference. The new issuer signature provides cryptographic proof that the issuer has authorized the change. This signature may be derived using the issuer's private cryptographic key and linked to the new version of the credential, ensuring that any entity verifying the credential can confirm that the update was performed by the original authorized issuer.

In some embodiments, the computing system 130 may store a new credential hash together with a previous credential hash and a corresponding issuer signature. These linked hashes form a verifiable chain of versions, where each new credential version references the hash of the previous one. This chain structure ensures that the entire history of the credential, from issuance to every subsequent update, is immutably recorded and can be reconstructed or verified at any time. The linked hashes may be stored both in an internal credential version store and on the distributed ledger for redundancy and transparency.

In some embodiments, the computing system 130 may create a new ledger record on the distributed ledger that includes the issuer identifier, the new credential hash, and a reference to the previous credential hash. The issuer identifier may correspond to a blockchain address, a decentralized identifier (DID), or another cryptographically verifiable identity associated with the issuer. This inclusion of both current and previous hashes, together with the issuer identifier, enables the distributed ledger to maintain a complete lineage of the credential. For example, a verifier can trace any credential update by following the sequence of ledger records, each pointing to its predecessor, thereby confirming the authenticity and continuity of the credential history. In some cases, the new ledger record is linked to previous ledger records corresponding to the same certificate.

In some embodiments, the computing system 130 may store a ledger reference corresponding to the new ledger record in a database or blockchain reference store. This ledger reference may include a blockchain transaction hash, block number, or other identifying pointer that enables efficient retrieval of the credential's on-chain record. Maintaining an indexed copy of the ledger reference allows the system to provide fast access to the blockchain data without requiring full ledger traversal, improving performance for verification and credential retrieval operations.

In some embodiments, the computing system 130 may execute a smart contract governing credential issuance or update conditions as part of recording the blockchain record. The smart contract may define the credentialing rules, such as permitted issuers, authorized schema types, or validation logic. When a credential update is submitted, the smart contract may validate compliance of the credential data with these predefined rules before the transaction is finalized. If the data passes validation, the smart contract generates an immutable transaction record confirming the credential issuance or update. This mechanism ensures that only valid, rule-compliant credentials are committed to the blockchain.

In some embodiments, the computing system 130 may use a decentralized identity framework to associate the issuer identity with a blockchain address. The system may link a decentralized identifier (DID) of the issuer to its cryptographic key pair, and the blockchain record may include a reference to this blockchain address for verifiable identification of the issuer. This linkage enables third parties to confirm that the blockchain transaction originated from a legitimate, recognized entity, rather than an unauthorized source.

In some embodiments, the computing system 130 may employ various types of blockchains depending on the use case, such as public, private, consortium, or permissioned networks. In a public blockchain implementation, the ledger record may be visible to all network participants, while sensitive data remains off-chain in hashed form. In a permissioned or enterprise blockchain, only approved nodes may participate in the validation of transactions, providing enhanced privacy and regulatory compliance. Regardless of blockchain type, each recorded ledger entry contributes to the tamper-proof audit trail of the credential's lifecycle.

In some embodiments, recording the blockchain record ensures that the certificate is cryptographically traceable to a blockchain address associated with the certificate issuer. This traceability provides verifiable proof of origin, allowing recipients and verifiers to confirm that the credential was created or updated by the authorized issuer. As a result, the distributed ledger serves not only as an immutable record of credential transactions but also as a transparent trust layer linking issuer identity, credential authenticity, and credential history across decentralized verification environments.

In some embodiments, the computing system 130 may generate 840 a representation of the certificate. In some embodiments, the representation is linked to the blockchain record and is updatable based on tracing linked blockchain records on the blockchain that represent changes to the credential of the named entity. The representation may take the form of a digital document, a web-based credential page, a JSON-LD file, or another human-or machine-readable format that allows secure sharing and verification. The representation may incorporate both visual and cryptographic components, including a human-readable layout and embedded metadata referencing the credential's blockchain record, issuer information, and version history.

In some embodiments, the computing system 130 may detect an external verified event associated with the named entity that triggers generation or update of the certificate representation. These external events may originate from integrated data sources such as academic databases, learning management systems, enterprise software platforms, or other systems of record that track achievements or milestones. For instance, completion of a professional training module or passing a certification exam may automatically prompt the system to generate or update a credential. When such an event occurs, the computing system 130 may automatically initiate a credential update workflow to modify credential content without requiring manual intervention from the issuer. The system may then record the updated credential version and a corresponding ledger entry on the blockchain, thereby ensuring that the certificate representation reflects the most current and verified data.

In some embodiments, the computing system 130 may communicate with external systems to retrieve verified achievement data associated with the named entity. The communication may occur via secured APIs or interoperable data exchange protocols. For example, an education partner platform may transmit a record of course completion directly to the computing system 130, which then validates and incorporates this data into the credential. Similarly, an employer's internal system may update an employee's credential to reflect a newly acquired skill or certification. These data exchanges allow the credential representation to remain accurate and current while maintaining verifiable links to external trusted data sources.

In some embodiments, the representation of the certificate may be generated in a human-readable format, such as a digital certificate image, diploma, or badge that visually conveys credential details while embedding blockchain verification links. The human-readable representation may include fields such as the credential holder's name, credential title, date of issuance, issuing organization, and a scannable element, such as a QR code or hyperlink, that references the blockchain record. This QR code or link allows any verifier to view the certificate's blockchain record and confirm its authenticity through the distributed ledger. The human-readable certificate may also dynamically update when new blockchain records representing updates are detected. For example, if an issuer updates the credential to include a new endorsement or modifies an expiration date, the certificate representation displayed to the recipient automatically synchronizes with the latest ledger record. Examples of the representations of the certificate are illustrated in FIG. 5A through FIG. 5H.

In some embodiments, generating the representation of the certificate may involve linking the human-readable representation to blockchain records corresponding to real-life events of the named entity. Each blockchain record may represent a verified event such as course completion, employment verification, or award recognition. By linking these event-based records, the representation evolves into a “living credential” that reflects the holder's verified status in real time. The linkage between event data and blockchain transactions allows for continuous validation of achievements as they occur, providing an up-to-date snapshot of the named entity's verified history.

In some embodiments, the computing system 130 may use a generative artificial intelligence model to create a credential template. The generative model may automatically design visual layouts and populate text or imagery based on issuer branding, credential type, and metadata from the request. For example, the AI model may generate a unique certificate background, incorporate organizational logos, and adapt the layout based on whether the credential represents an academic achievement, professional license, or digital award. The system may further generate certificate imagery and metadata and mint the final representation as a verifiable digital asset recorded on the distributed ledger. This ensures that both the visual and data layers of the certificate are cryptographically bound to the blockchain record and verifiable by third parties.

In some embodiments, the computing system 130 may assign dynamic privileges associated with the credential. These privileges may include access rights, benefits, or entitlements linked to the verified credential. For example, a digital event ticket credential may grant entry to an event, while a professional certification credential may unlock access to restricted resources or membership programs. The computing system 130 may store benefit parameters and conditions in a smart contract recorded on the distributed ledger. When a predefined condition is met, such as the credential holder completing a milestone or achieving a qualifying score, the smart contract may automatically update the dynamic privileges associated with the credential. This configuration ensures that the credential remains an active gateway to verified opportunities and privileges.

In some embodiments, the certificate representation may also support a community environment linked to the credential. The named entity may use the certificate to access a digital space or community reserved for verified credential holders. For instance, a university-issued digital diploma may grant access to alumni networks, or a product authenticity certificate may provide entry to exclusive brand-owner forums. The computing system 130 may track engagement through credential-linked events and record corresponding usage history on the distributed ledger, thereby maintaining verifiable records of credential-based interactions.

In some embodiments, the credential representation may include embedded verification data and refresh mechanisms. For example, when the credential is represented as a JSON-LD document, it may include a refresh service that automatically retrieves the latest credential version from the computing system 130 whenever the recipient or verifier accesses it. This ensures that the credential representation is never stale and always synchronized with its most recent blockchain state. By combining human-readable presentation, AI-assisted design, external event integration, and dynamic privilege management, the computing system 130 ensures that each certificate representation is both visually informative and cryptographically verifiable as an up-to-date reflection of the named entity's real-world achievements.

In some embodiments, the computing system 130 may transmit 850 the representation of the certificate to the named entity as a credential proof. The transmission step marks the completion of the certificate generation or update process, allowing the credential holder to receive, access, and verify the issued credential through one or more secure communication channels. The computing system 130 may deliver the credential representation through email, an in-application message, a secure web portal, a digital wallet, or another verifiable credential management interface. Each transmission may include a unique access link or a scannable identifier, such as a QR code, that connects the recipient directly to the blockchain ledger record associated with the certificate.

In some embodiments, the computing system 130 may notify the recipient device that a new credential or credential update is available. The notification may include a link to the credential's representation hosted by the computing system 130 or embedded directly within a decentralized storage network. The notification may also specify metadata, such as issuance timestamp, credential type, and version number. For example, when a university issues a diploma, the recipient may receive an automated message containing a link to view and download the diploma. Similarly, when an organization updates a professional certification, the credential holder may receive a message indicating that a new version has been recorded and is ready for verification. These notifications ensure transparency and immediate access to verified credential updates.

In some embodiments, the transmitted certificate representation may take the form of a document that includes both visual and cryptographic elements. The document may contain an issuer digital signature, credential metadata, and a blockchain ledger reference. The issuer digital signature provides a verifiable mark of authenticity, ensuring that the credential originates from the authorized issuer. The credential metadata may include fields such as credential title, holder name, issuing organization, and relevant timestamps. The blockchain ledger reference, such as a transaction hash or block number, enables any verifier to independently confirm the credential's existence and integrity on the distributed ledger. Together, these elements allow the transmitted credential to serve as both a readable proof of achievement and a cryptographically verifiable record.

In some embodiments, verifying authenticity of the transmitted certificate may include retrieving a public cryptographic key of the issuer and validating the issuer's digital signature using that key. The verification process may be performed either automatically by the computing system 130 or manually by a third-party verifier through a verification portal. The verifier may compute a new hash based on information contained in the certificate representation and compare it with the stored credential hash retrieved from the distributed ledger. When the computed and stored hashes match, the verifier confirms that the credential has not been altered since issuance. This multi-layered verification mechanism ensures that the transmitted certificate maintains its evidentiary value and integrity regardless of where it is stored or displayed.

In some embodiments, the computing system 130 may enable the named entity to store and manage the transmitted credential within a secure digital wallet or identity management application. The credential holder may import the certificate into an external platform that supports verifiable credentials, such as a decentralized identity (DID) wallet. These digital wallets allow the holder to selectively share the credential with external verifiers, such as employers, educational institutions, or professional organizations, while maintaining control over their personal data. The credential holder may, for example, share a verification link or QR code embedded in the certificate representation, enabling real-time validation of the credential's authenticity through the blockchain ledger.

In some embodiments, transmitting the credential proof may further comprise enabling the named entity to access a connected community environment based on verified credentials. For example, a recipient holding a blockchain-verified event certificate may gain access to an exclusive professional forum, alumni network, or brand membership portal. The computing system 130 may track engagement of the named entity within these environments through credential-linked events, such as participation in community activities, redemption of rewards, or attendance at certified events. These interactions may then be recorded on the distributed ledger, providing a verifiable record of credential usage and engagement over time.

In some embodiments, the computing system 130 may maintain an immutable ledger record of all transmitted certificates and credential interactions for audit and compliance purposes. The transmission event itself may be recorded on the blockchain or in an internal log, linking the credential identifier with transmission metadata such as recipient identity, timestamp, and delivery channel. This ensures that the full lifecycle of the credential, from creation, update, and issuance to delivery, is cryptographically traceable and verifiable.

In some embodiments, the transmitted credential may include embedded refresh instructions or smart links that allow it to dynamically update when subsequent blockchain transactions occur. For example, if a credential is later revised or extended, the holder's digital wallet or credential viewer may automatically fetch the updated representation from the computing system 130, ensuring that the holder always possesses the latest verified version. This feature enhances long-term reliability and usability of blockchain-linked credentials without requiring manual reissuance.

In some embodiments, the computing system 130 may use encryption and secure transmission protocols such as HTTPS, TLS, or blockchain-based messaging systems to protect credential data during delivery. Sensitive information may be encrypted end-to-end, ensuring that only the intended recipient can decrypt and access the credential. The system may also implement integrity checks to detect transmission tampering or interception attempts.

Through these mechanisms, transmitting the certificate to the named entity as a credential proof completes the blockchain-based credential lifecycle. The named entity receives a secure, verifiable, and dynamically updatable credential that can be authenticated through the distributed ledger at any time. This approach ensures persistent trust, transparency, and portability of digital credentials across organizational and technological boundaries.

### Computing Machine Architecture

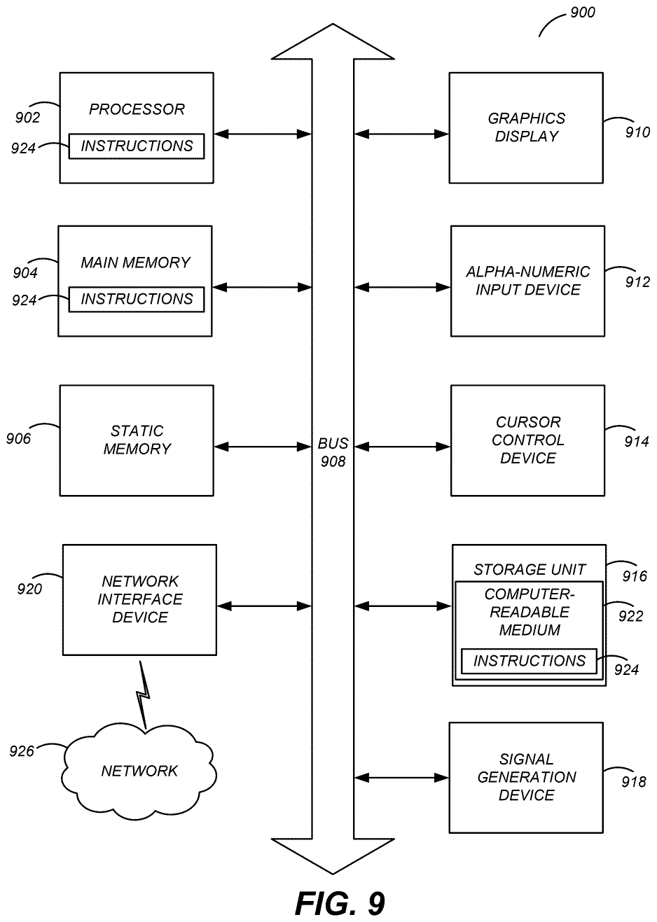

FIG. 9 is a block diagram illustrating components of an example computing machine that is capable of reading instructions from a computer-readable medium and execute them in a processor (or controller). A computer described herein may include a single computing machine shown in FIG. 9, a virtual machine, a distributed computing system that includes multiples nodes of computing machines shown in FIG. 9, or any other suitable arrangement of computing devices.

By way of example, FIG. 9 shows a diagrammatic representation of a computing machine in the example form of a computer system 900 within which instructions 924 (e.g., software, program code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 9 may correspond to any software, hardware, or combined components shown in FIGS. 1 and 2, including but not limited to, the user device 110, the computing system 130, a node of a blockchain network, and various components shown in FIG. 2. While FIG. 9 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 924 that specify actions to be taken by that machine. Further, while only a single machine is illustrated, the term “machine” shall also be taken to include any collection of machines that individually or jointly execute instructions 924 to perform any one or more of the methodologies discussed herein.

The example computer system 900 includes one or more processors (generally, processor 902) (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 904, and a static memory 906, which are configured to communicate with each other via a bus 908. The computer system 900 may further include graphics display unit 910 (e.g., a plasma display panel (PDP), a liquid crystal display (LCD), a projector, or a cathode ray tube (CRT)). The computer system 900 may also include alphanumeric input device 912 (e.g., a keyboard), a cursor control device 914 (e.g., a mouse, a trackball, a joystick, a motion sensor, or other pointing instrument), a storage unit 916, a signal generation device 918 (e.g., a speaker), and a network interface device 920, which also are configured to communicate via the bus 908.

The storage unit 916 includes a computer-readable medium 922 on which is stored instructions 924 embodying any one or more of the methodologies or functions described herein. The instructions 924 may also reside, completely or at least partially, within the main memory 904 or within the processor 902 (e.g., within a processor's cache memory) during execution thereof by the computer system 900, the main memory 904 and the processor 902 also constituting computer-readable media. The instructions 924 may be transmitted or received over a network 926 via the network interface device 920.

While computer-readable medium 922 is shown in an example embodiment to be a single medium, the term “computer-readable medium” should be taken to include a single medium or multiple media (e.g., a centralized or distributed database, or associated caches and servers) able to store instructions (e.g., instructions 924). The computer-readable medium may include any medium that is capable of storing instructions (e.g., instructions 924) for execution by the machine and that cause the machine to perform any one or more of the methodologies disclosed herein. The computer-readable medium may include, but not be limited to, data repositories in the form of solid-state memories, optical media, and magnetic media. The computer-readable medium does not include a transitory medium such as a signal or a carrier wave.

### Additional Configuration Considerations

Certain embodiments are described herein as including logic or a number of components, engines, modules, or mechanisms, for example, as illustrated in FIG. 2. Engines may constitute either software modules (e.g., code embodied on a computer-readable medium) or hardware modules. A hardware engine is a tangible unit capable of performing certain operations and may be configured or arranged in a certain manner. In example embodiments, one or more computer systems (e.g., a standalone, client or server computer system) or one or more hardware engines of a computer system (e.g., a processor or a group of processors) may be configured by software (e.g., an application or application portion) as a hardware engine that operates to perform certain operations as described herein.

In various embodiments, a hardware engine may be implemented mechanically or electronically. For example, a hardware engine may comprise dedicated circuitry or logic that is permanently configured (e.g., as a special-purpose processor, such as a field programmable gate array (FPGA) or an application-specific integrated circuit (ASIC)) to perform certain operations. A hardware engine may also comprise programmable logic or circuitry (e.g., as encompassed within a general-purpose processor or another programmable processor) that is temporarily configured by software to perform certain operations. It will be appreciated that the decision to implement a hardware engine mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 802, that are temporarily configured (e.g., by software) or permanently configured to perform the relevant operations. Whether temporarily or permanently configured, such processors may constitute processor-implemented engines that operate to perform one or more operations or functions. The engines referred to herein may, in some example embodiments, comprise processor-implemented engines.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Upon reading this disclosure, those of skill in the art will appreciate still additional alternative structural and functional designs for a similar system or process through the disclosed principles herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

1. A system comprising:
a blockchain comprising a distributed ledger; and
a computing system in communication with the blockchain, the computing system comprising memory and one or more processors, memory storing executable instructions, wherein the executable instructions, when executed by the one or more processors, cause the one or more processors to:
receive a request for generating a certificate that represents credential of a named entity;
apply a private cryptographic key corresponding to a certificate issuer to generate a blockchain record based on information provided in the request, the blockchain record comprising (1) a reference to a version of a public cryptographic key and (2) a hash of the information such that the information is cryptographically verifiable;
record the blockchain record on the distributed ledger of the blockchain, wherein the blockchain record is cryptographically traceable to a blockchain address associated with the certificate issuer;
generate a representation of the certificate, wherein the representation is linked to the blockchain record and is updatable based on tracing linked blockchain records on the blockchain that represent changes to the credential of the named entity; and
transmit the representation of the certificate to the named entity as a credential proof.

2. The system of claim 1, wherein the request for generating the certificate comprises an update request for a previously issued certificate.

3. The system of claim 1, wherein applying the private cryptographic key corresponding to the certificate issuer comprises:
validating claims associated with the request;
generating a cryptographic hash representing the claims, wherein the cryptographic hash is the hash of the information; and
applying the private cryptographic key to digitally sign the cryptographic hash to bind an identity of the certificate issuer to the claims.

4. The system of claim 1, wherein recording the blockchain record on the distributed ledger comprises:
retrieving a previously stored credential hash associated with the certificate;
comparing the cryptographic hash representing an updated credential content with the previously stored credential hash;
calculating a difference representing changes between credential versions; and
generating a new issuer signature corresponding to the difference.

5. A computer-implemented method, comprising:
receiving a request for generating a certificate that represents credential of a named entity;
applying a private cryptographic key corresponding to a certificate issuer to generate a blockchain record based on information provided in the request, the blockchain record comprising (1) a reference to a version of a public cryptographic key and (2) a hash of the information such that the information is cryptographically verifiable;
recording the blockchain record on a distributed ledger of a blockchain, wherein the blockchain record is cryptographically traceable to a blockchain address associated with the certificate issuer;
generating a representation of the certificate, wherein the representation is linked to the blockchain record and is updatable based on tracing linked blockchain records on the blockchain that represent changes to the credential of the named entity; and
transmitting the representation of the certificate to the named entity as a credential proof.

6. The computer-implemented method of claim 5, wherein the request for generating the certificate comprises an update request for a previously issued certificate.

7. The computer-implemented method of claim 5, wherein applying the private cryptographic key corresponding to the certificate issuer comprises:
validating claims associated with the request;
generating a cryptographic hash representing the claims, wherein the cryptographic hash is the hash of the information; and
applying the private cryptographic key to digitally sign the cryptographic hash to bind an identity of the certificate issuer to the claims.

8. The computer-implemented method of claim 5, wherein recording the blockchain record on the distributed ledger comprises:
retrieving a previously stored credential hash associated with the certificate;
comparing the cryptographic hash representing an updated credential content with the previously stored credential hash;
calculating a difference representing changes between credential versions; and
generating a new issuer signature corresponding to the difference.

9. The computer-implemented method of claim 5, wherein recording the blockchain record on the distributed ledger further comprises:
storing a new credential hash together with a previous credential hash and a corresponding issuer signature;
creating a new ledger record on the distributed ledger containing an issuer identifier, the new credential hash, and a reference to the previous credential hash; and
storing a ledger reference corresponding to the new ledger record.

10. The computer-implemented method of claim 5, wherein the representation of the certificate transmitted to the named entity as the credential proof comprises a document, and wherein verifying authenticity of the certificate comprises:
including, in the document, an issuer digital signature, credential metadata, and a blockchain ledger reference;
retrieving a public cryptographic key of the issuer; and
authenticating the document by validating the issuer digital signature using the public cryptographic key.

11. The computer-implemented method of claim 5, further comprising verifying authenticity of the certificate, wherein verifying the authenticity comprises:
computing a new hash of based on information in the representation of the certificate;
retrieving, from the distributed ledger, a stored credential hash corresponding to the certificate; and
determining authenticity of the certificate responsive to the new hash matching the stored credential hash recorded on the distributed ledger.

12. The computer-implemented method of claim 5, wherein generating the representation of the certificate comprises:
detecting an external verified event associated with the named entity;
automatically initiating, responsive to the external verified event, a credential update workflow to modify credential content; and
recording, on the distributed ledger, an updated credential version and a corresponding ledger entry without manual intervention from the certificate issuer.

13. The computer-implemented method of claim 5, wherein generating the representation of the certificate comprises:
communicating with an external system;
retrieving, from the external system, verified achievement data associated with the named entity; and
updating credential content based on the achievement data.

14. The computer-implemented method of claim 5, wherein representation of the certificate is human-readable, and wherein generate the representation of the certificate comprises:
linking the human-readable representation to blockchain records corresponding to real-life events of the named entity;
updating the human-readable representation to reflect verified new event associated with the named entity; and
dynamically modifying a privilege associated with the certificate based on a verified state recorded on the distributed ledger.

15. The computer-implemented method of claim 5, wherein recording the blockchain record on the distributed ledger further comprises:
executing a smart contract governing credential issuance;
validating compliance of credential data with predefined credentialing rules; and
generating an immutable transaction record confirming the credential issuance or update in accordance with the smart contract.

16. The computer-implemented method of claim 5, wherein the certificate issuer comprises an entity having a decentralized identifier recorded on a decentralized identity framework, and wherein generating the blockchain record further comprises:
associating the decentralized identifier with a cryptographic key pair;
linking the cryptographic key pair to a blockchain address of the certificate issuer; and
recording a reference to the blockchain address in the distributed ledger for verifiable identification of the certificate issuer.

17. The computer-implemented method of claim 5, wherein generating the representation of the certificate comprises:
using a generative artificial intelligence model to create a credential template;
automatically generating certificate imagery and metadata based on information provided in the request; and
minting the generated certificate as a verifiable digital asset recorded on the distributed ledger.

18. The computer-implemented method of claim 5, wherein generating the representation of the certificate comprises:
assigning a dynamic privilege associated with the credential;
storing a benefit parameter and condition in a smart contract recorded on the distributed ledger; and
automatically updating the dynamic privilege when the benefit parameter and condition is met as determined by the smart contract.

19. The computer-implemented method of claim 5, wherein transmitting the representation of the certificate to the named entity comprises:
enabling the named entity to access a community environment based on verified credentials;
tracking engagement of the named entity through a credential-linked event; and
recording, on the distributed ledger, credential usage history to provide verifiable engagement information.

20. A non-transitory computer-readable medium configured to store code comprising executable instructions, wherein the executable instructions, when executed by one or more processors, cause the one or more processors to perform steps comprising:
receiving a request for generating a certificate that represents credential of a named entity;
applying a private cryptographic key corresponding to a certificate issuer to generate a blockchain record based on information provided in the request, the blockchain record comprising (1) a reference to a version of a public cryptographic key and (2) a hash of the information such that the information is cryptographically verifiable;
recording the blockchain record on a distributed ledger of a blockchain, wherein the blockchain record is cryptographically traceable to a blockchain address associated with the certificate issuer;
generating a representation of the certificate, wherein the representation is linked to the blockchain record and is updatable based on tracing linked blockchain records on the blockchain that represent changes to the credential of the named entity; and
transmitting the representation of the certificate to the named entity as a credential proof.
